(19) United States
(12) Patent Application Publication
(10) Pub. No.: US 2025/0111122 A1
(43) Pub. Date: Apr. 3, 2025

(54) TECHNIQUES FOR USING INVERSE DESIGN FOR COMBINED OPTIMIZATION OF OPTICAL AND ELECTRICAL COMPONENTS IN AN OPTOELECTRONIC RECEIVER

(71) Applicant: X Development LLC, Mountain View, CA (US)

(72) Inventors: Brian Adolf, San Mateo, CA (US); Yi-Kuei Ryan Wu, San Jose, CA (US); Ian Williamson, Palo Alto, CA (US)

(21) Appl. No.: 18/479,724

(22) Filed: Oct. 2, 2023

(51) Int. Cl. G06F 30/392; G06F 119/06

(52) U.S. Cl. CPC G06F 30/392; G06F 2119/06

(57) ABSTRACT

In some embodiments, a computer-implemented method of creating a design for an optoelectronic detector device is provided. A computing system determines an initial design that includes circuit parameters for at least one photodetector region and for conductors that couple the photodetector region to circuitry. The computing system simulates performance of an optically active region to generate a plurality of field values, and simulates performance of the at least one photodetector region based on the plurality of field values to generate charge values. The computing system simulates performance of at least the conductors based on the charge values to generate a performance loss value, and determines a loss metric based on the performance loss value. The computing system backpropagates the loss metric to determine a circuit parameter gradient, and revises the circuit parameters based at least in part on the circuit parameter gradient to create an updated initial design.

### TECHNICAL FIELD

This disclosure relates generally to photonic devices, and in particular but not exclusively, relates to optoelectronic photodetectors.

### BACKGROUND

Fiber-optic communication is typically employed to transmit information from one place to another via light that has been modulated to carry the information. For example, many telecommunication companies use optical fiber to transmit telephone signals, internet communication, and cable television signals. At a transmitting side, information is modulated onto a carrier beam that is transmitted via the optical fiber. At a receiving side, an optoelectronic photodetector and related circuitry is used to detect the signal and decode the information.

### BRIEF SUMMARY

In some embodiments, a non-transitory computer-readable medium having computer-executable instructions stored thereon is provided. The instructions, in response to execution by one or more processors of a computing system, cause the computing system to perform actions for creating a design for an optoelectronic detector device, the actions comprising: determining, by the computing system, an initial design that includes structural parameters for an optically active region and circuit parameters for at least one photodetector region and for conductors that couple the photodetector region to circuitry; simulating, by the computing system, performance of the optically active region to generate a plurality of field values; simulating, by the computing system, performance of the at least one photodetector region based on the plurality of field values to generate charge values; simulating, by the computing system, performance of at least the conductors based on the charge values to generate a performance loss value; determining, by the computing system, a loss metric based on the performance loss value; backpropagating, by the computing system, the loss metric to determine at least a circuit parameter gradient; and revising, by the computing system, the circuit parameters based at least in part on the circuit parameter gradient to create an updated initial design.

In some embodiments, a computer-implemented method of creating a design for an optoelectronic detector device is provided. A computing system determines an initial design that includes structural parameters for an optically active region and circuit parameters for at least one photodetector region and for conductors that couple the photodetector region to circuitry. The computing system simulates performance of the optically active region to generate a plurality of field values. The computing system simulates performance of the at least one photodetector region based on the plurality of field values to generate charge values. The computing system simulates performance of at least the conductors based on the charge values to generate a performance loss value. The computing system determines a loss metric based on the performance loss value. The computing system backpropagates the loss metric to determine at least a circuit parameter gradient. The computing system revises the circuit parameters based at least in part on the circuit parameter gradient to create an updated initial design.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a functional block diagram illustrating a non-limiting example embodiment of a system for optical communication between two optical communication devices via an optical signal, according to various aspects of the present disclosure.

FIG. 2A-FIG. 2D illustrate different views of a non-limiting example embodiment of a photonic demultiplexer, according to various aspects of the present disclosure.

FIG. 3A and FIG. 3B illustrate a more detailed cross-sectional view of a dispersive region of a non-limiting example embodiment of a photonic demultiplexer, according to various aspects of the present disclosure.

FIG. 4 is a schematic illustration of a non-limiting example embodiment of an optoelectronic receiver according to various aspects of the present disclosure.

FIG. 5 is a functional block diagram illustrating a non-limiting example embodiment of a system for generating a design of a photonic integrated circuit, according to various aspects of the present disclosure.

FIG. 6A-FIG. 6C respectively illustrate non-limiting example embodiments of an initial set up of a simulated environment describing a photonic device, performing an operational simulation of the photonic device in response to an excitation source within the simulated environment, and performing an adjoint simulation of the photonic device within the simulated environment according to various aspects of the present disclosure.

FIG. 7A-FIG. 7B are schematic illustrations of a design of a physical device such as an optoelectronic receiver to be optimized according to various aspects of the present disclosure.

FIG. 8A is a flow chart illustrating example time steps for an operational simulation and an adjoint simulation, in accordance with various aspects of the present disclosure.

FIG. 8B is a chart illustrating the relationship between the update operation for the operational simulation and the adjoint simulation (e.g., backpropagation), in accordance with an embodiment of the present disclosure.

FIG. 9A and FIG. 9B illustrate a non-limiting example embodiment of an eye diagram according to various aspects of the present disclosure.

FIG. 10 is a flowchart that illustrates a non-limiting example embodiment of a method for generating a design of physical device such as a photonic integrated circuit, in accordance with various aspects of the present disclosure.

### DETAILED DESCRIPTION

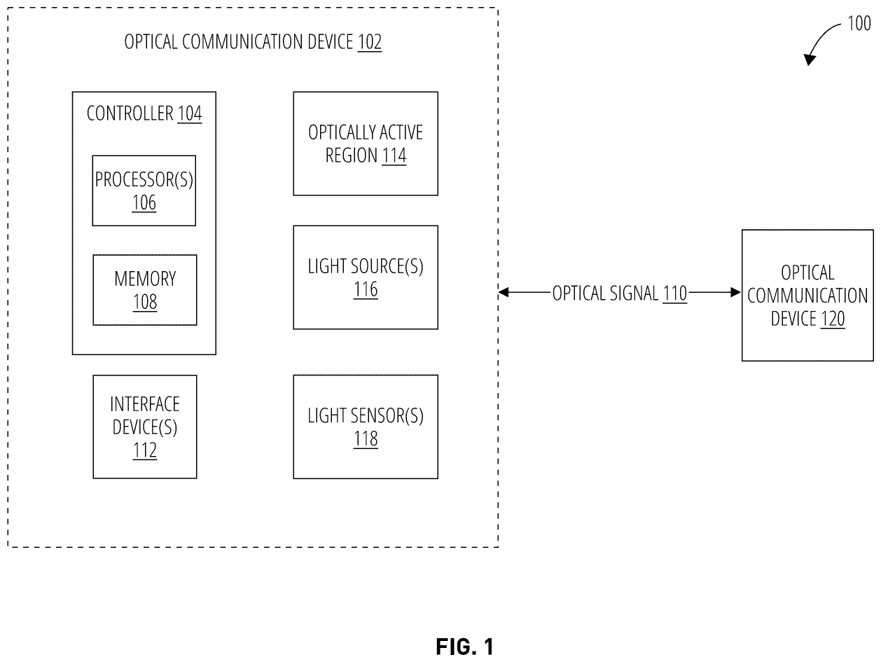

FIG. 1 is a functional block diagram illustrating a system 100 for optical communication between optical communication device 102 and optical communication device 120 via optical signal 110, in accordance with various aspects of the present disclosure. More generally, in some embodiments, optical communication device 102 is configured to transmit information by modulating light from one or more light source(s) 116 into an optical signal 110 that is subsequently transmitted from optical communication device 102 to optical communication device 120 via an optical fiber, a light guide, a wave guide, or other photonic device. Optical communication device 120 receives the multi-channel optical signal 110 and demodulates the received optical signal 110 to extract the transmitted information. In some embodiments, optical communication device 102 is configured to receive information by demodulating optical signal 110 transmitted by optical communication device 120, as detected by one or more light sensor(s) 118, to recover the transmitted information. In some embodiments, optical communication device 102 may be configured to both transmit (via one or more light source(s) 116) and receive (via one or more light sensor(s) 118) information. In some embodiments, optical communication device 102 may be configured to perform one of transmitting or receiving information.

It is appreciated that in some embodiments optical communication device 102 and optical communication device 120 may be distinct and separate devices (e.g., an optical transceiver or transmitter communicatively coupled via one or more optical fibers to a separate optical transceiver or receiver). However, in other embodiments, optical communication device 102 and optical communication device 120 may be part of a singular component or device (e.g., a smartphone, a tablet, a computer, optical device, or the like). For example, optical communication device 102 and optical communication device 120 may both be constituent components on a monolithic integrated circuit that are coupled to one another via a waveguide that is embedded within the monolithic integrated circuit and is adapted to carry optical signal 110 between optical communication device 102 and optical communication device 120 or otherwise transmit the optical signal between one place and another.

In the illustrated embodiment, optical communication device 102 includes a controller 104, one or more interface device(s) 112 (e.g., fiber optic couplers, light guides, waveguides, and the like), an optically active region 114, one or more light source(s) 116 (e.g., light emitting diodes, lasers, and the like), and one or more light sensor(s) 118 (e.g., photodiodes, phototransistors, photoresistors, and the like) coupled to one another. The controller 104 includes one or more processor(s) 106 (e.g., one or more central processing units, application specific circuits, field programmable gate arrays, or otherwise) and memory 108 (e.g., volatile memory such as DRAM and SAM, non-volatile memory such as ROM, flash memory, and the like). It is appreciated that optical communication device 120 may include the same or similar elements as optical communication device 102, which have been omitted for clarity. It is also appreciated that if the optical communication device 102 is configured to receive signals but not transmit signals, the light source(s) 116 may be omitted, while if the optical communication device 102 is configured to transmit signals but not receive signals, the light sensor(s) 118 may be omitted.

Controller 104 orchestrates operation of optical communication device 102 for transmitting and/or receiving optical signal 110. Controller 104 includes software (e.g., instructions included in memory 108 coupled to processor 106) and/or hardware logic (e.g., application specific integrated circuits, field-programmable gate arrays, and the like) that when executed by controller 104 causes controller 104 and/or optical communication device 102 to perform operations.

In one embodiment, controller 104 may choreograph operations of optical communication device 102 to cause light source(s) 116 to generate a signal that is transmitted via optically active region 114 into a modulated optical signal 110 that is subsequently transmitted to optical communication device 120 via interface device 112. In the same or another embodiment, controller 104 may choreograph operations of optical communication device 102 to cause a modulated signal to be received via optically active region 114 via interface device 112 from optical communication device 120, and detected by the light sensor(s) 118.

It is appreciated that in some embodiments certain elements of optical communication device 102 and/or optical communication device 120 may have been omitted to avoid obscuring certain aspects of the disclosure. For example, optical communication device 102 and optical communication device 120 may include amplification circuitry, lenses, or components to facilitate transmitting and receiving optical signal 110. It is further appreciated that in some embodiments optical communication device 102 and/or optical communication device 120 may not necessarily include all elements illustrated in FIG. 1.

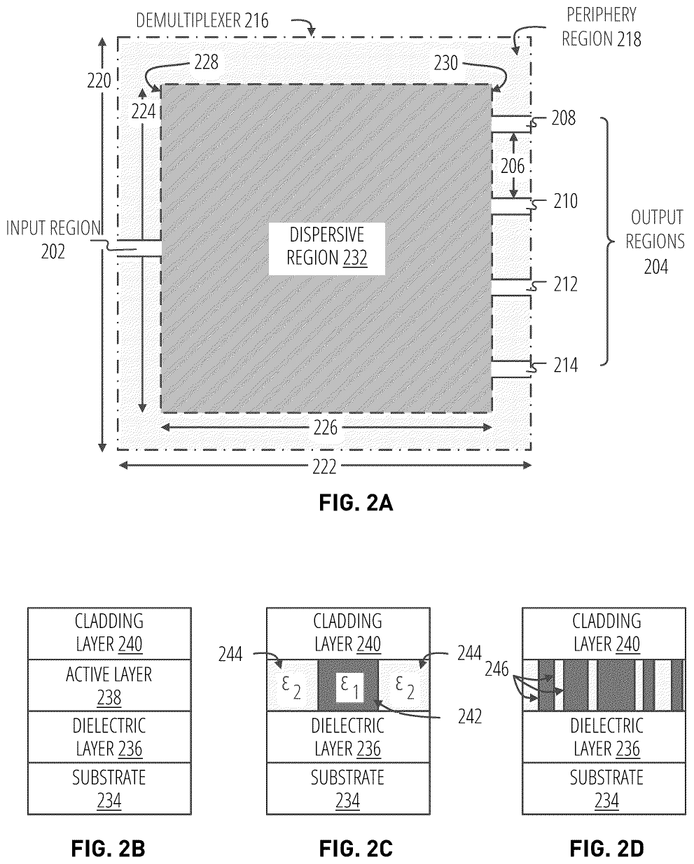

FIG. 2A-FIG. 2D illustrate different views of an example photonic demultiplexer, in accordance with an embodiment of the present disclosure. Photonic demultiplexer 216 is one possible implementation of functionality provided by optically active region 114 illustrated in FIG. 1. It is further appreciated that while discussion henceforth may be directed towards photonic integrated circuits capable of demultiplexing a plurality of distinct wavelength channels from a multi-channel optical signal, that in other embodiments, a demultiplexer (e.g., demultiplexer 216) may also or alternatively be capable of multiplexing a plurality of distinct wavelength channels into a multi-channel optical signal or performing other manipulation of incoming optical signals, in accordance with embodiments of the present disclosure. The demultiplexer 216 is illustrated because it is an example that clearly shows the manipulation of the incoming optical signal toward a particular physical region of the physical device, and such functionality would be similarly useful for guiding the optical signal towards photosensitive elements in a receiver as described in further detail below.

FIG. 2A illustrates a cross-sectional view of demultiplexer 216 along a lateral plane within an active layer defined by a width 220 and a length 222 of the demultiplexer 216. As illustrated, demultiplexer 216 includes an input region 202, a plurality of output regions 204, and a dispersive region optically disposed between the input region 202 and plurality of output regions 204. The input region 202 and plurality of output regions 204 (e.g., output region 208, output region 210, output region 212, and output region 214) may each be waveguides (e.g., slab waveguide, strip waveguide, slot waveguide, or the like) capable of propagating light along the path of the waveguide. The dispersive region 232 includes a first material and a second material (see, e.g., FIG. 2D) inhomogeneously interspersed to form a plurality of interfaces that each correspond to a change in refractive index of the dispersive region 232 and collectively structure the dispersive region 232 to optically separate each of a plurality of distinct wavelength channels (e.g., Ch. 1, Ch. 2, Ch. 3, . . . . Ch. N) from a multi-channel optical signal and respectively guide each of the plurality of distinct wavelength channels to a corresponding one of the plurality of output regions 204 when the input region 202 receives the multi-channel optical signal. In other words, input region 202 is adapted to receive the multi-channel optical signal including a plurality of distinct wavelength channels and the plurality of output regions 204 are adapted to each receive a corresponding one of the plurality of distinct wavelength channels demultiplexed from the multi-channel optical signal via dispersive region 232.

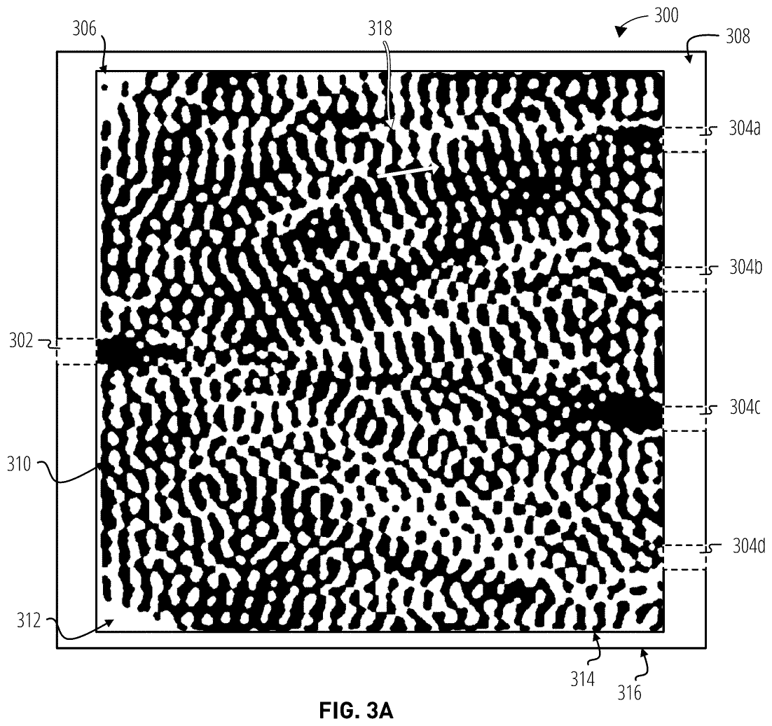

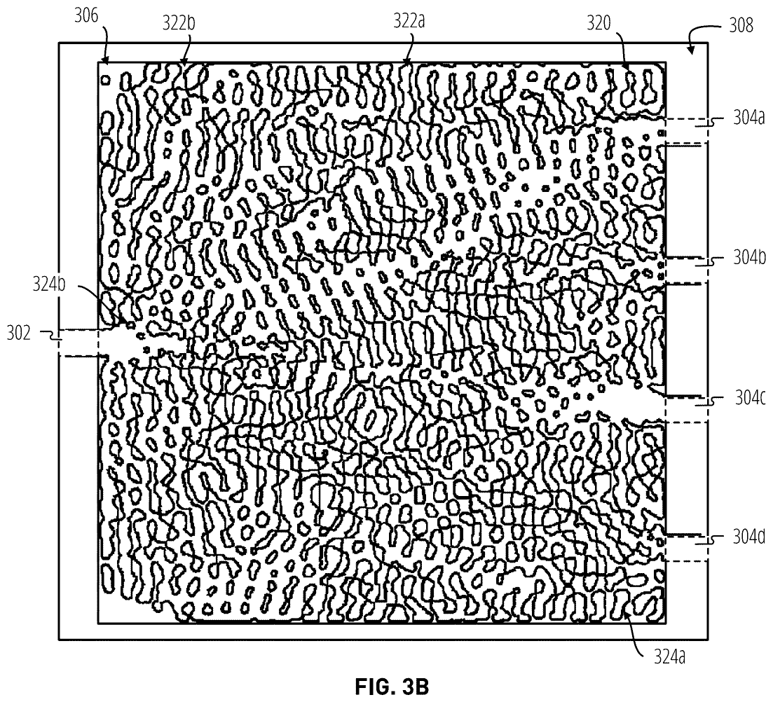

As illustrated in FIG. 2A, and more clearly shown in FIG. 2D and FIG. 3A-FIG. 3B, the shape and arrangement of the first and second material that are inhomogeneously interspersed create a plurality of interfaces that collectively form a material interface pattern along a cross-sectional area of dispersive region 232 that is at least partially surrounded by a periphery region 218 that includes the second material. In some embodiments periphery region 218 has a substantially homogeneous composition that includes the second material. In the illustrated embodiment, dispersive region 232 includes a first side 228 and a second side 230 that each interface with an inner boundary (i.e., the unlabeled dashed line of periphery region 218 disposed between dispersive region 232 and dashed-dotted line corresponding to an outer boundary of periphery region 218). First side 228 and second side 230 are disposed correspond to opposing sides of dispersive region 232. Input region 202 is disposed proximate to first side 228 (e.g., one side of input region 202 abuts first side 228 of dispersive region 232) while each of the plurality of output regions 204 are disposed proximate to second side 230 (e.g., one side of each of the plurality of output regions 204 abuts second side 230 of dispersive region 232).

In the illustrated embodiment each of the plurality of output regions 204 are parallel to each other one of the plurality of output regions 204. However, in other embodiments the plurality of output regions 204 may not be parallel to one another or even disposed on the same side (e.g., one or more of the plurality of output regions 204 and/or input region 202 may be disposed proximate to sides of dispersive region 232 that are adjacent to first side 228 and/or second side 230). In some embodiments adjacent ones of the plurality of output regions are separated from each other by a common separation distance when the plurality of output regions includes at least three output regions. For example, as illustrated adjacent output region 208 and output region 210 are separated from one another by distance 206, which may be common to the separation distance between other pairs of adjacent output regions.

As illustrated in the embodiment of FIG. 2A, demultiplexer 216 includes four output regions 204 (e.g., output region 208, output region 210, output region 212, output region 214) that are each respectively mapped (i.e., by virtue of the structure of dispersive region 232) to a respective one of four channels included in a plurality of distinct wavelength channels. More specifically, the plurality of interfaces of dispersive region 232, defined by the inhomogeneous interspersion of a first material and a second material, form a material interface pattern along a cross-sectional area of the dispersive region 232 (e.g., as illustrated in FIG. 2A, FIG. 3A, or FIG. 3B) to cause the dispersive region 232 to optically separate each of the four channels from the multi-channel optical signal and route each of the four channels to a respective one of the four output regions 204 when the input region 202 regions the multi-channel optical signal.

It is noted that the first material and second material of dispersive region 232 are arranged and shaped within the dispersive region such that the material interface pattern is substantially proportional to a design obtainable with an inverse design process, which will be discussed in greater detail later in the present disclosure. More specifically, in some embodiments, the inverse design process may include iterative gradient-based optimization of a design based at least in part on a loss function that incorporates a performance loss (e.g., to enforce functionality) and a fabrication loss (e.g., to enforce fabricability and binarization of a first material and a second material) that is reduced or otherwise adjusted via iterative gradient-based optimization to generate the design. In the same or other embodiments, other optimization techniques may be used instead of, or jointly with, gradient-based optimization. Advantageously, this allows for optimization of a near unlimited number of design parameters to achieve functionality and performance within a predetermined area that may not have been possible with conventional design techniques.

For example, in one embodiment, dispersive region 232 is structured to optically separate each of the four channels from the multi-channel optical signal within a predetermined area of 35 μm×35 μm (e.g., as defined by width 224 and length 226 of dispersive region 232) when the input region 202 receives the multi-channel optical signal. In the same or another embodiment, the dispersive region is structured to accommodate a common bandwidth for each of the four channels, each of the four channels having different center wavelengths. In one embodiment the common bandwidth is approximately 13 nm wide and the different center wavelengths is selected from a group consisting of 1271 nm, 1291 nm, 1311 nm, 1331 nm, 1506 nm, 1514 nm, 1551 nm, and 1571 nm. In some embodiments, the entire structure of demultiplexer 216 (e.g., including input region 202, periphery region 218, dispersive region 232, and plurality of output regions 204) fits within a predetermined area (e.g., as defined by width 220 and length 222). In one embodiment the predetermined area is 35 μm×35 μm. It is appreciated that in other embodiments dispersive region 232 and/or demultiplexer 216 fits within other areas greater than or less than 35 μm×35 μm, which may result in changes to the structure of dispersive region 232 (e.g., the arrangement and shape of the first and second material) and/or other components of demultiplexer 216.

In the same or other embodiments the dispersive region is structured to have a power transmission of −2 dB or greater from the input region 202, through the dispersive region 232, and to the corresponding one of the plurality of output regions 204 for a given wavelength within one of the plurality of distinct wavelength channels. For example, if channel 1 of a multi-channel optical signal is mapped to output region 208, then when demultiplexer 216 receives the multi-channel optical signal at input region 202 the dispersive region 232 will optically separate channel 1 from the multi-channel optical signal and guide a portion of the multi-channel optical signal corresponding to channel 1 to output region 208 with a power transmission of −2 dB or greater. In the same or another embodiment, dispersive region 232 is structured such that an adverse power transmission (i.e., isolation) for the given wavelength from the input region to any of the plurality of output regions other than the corresponding one of the plurality of output regions is −30 dB or less, −22 dB or less, or otherwise. For example, if channel 1 of a multi-channel optical signal is mapped to output region 208, then the adverse power transmission from input region 202 to any other one of the plurality of output regions (e.g., output region 210, output region 212, output region 214) other than the corresponding one of the plurality of output regions (e.g., output region 208) is −30 dB or less, −22 dB or less, or otherwise. In some embodiments, a maximum power reflection from demultiplexer 216 of an input signal (e.g., a multi-channel optical signal) received at an input region (e.g., input region 202) is reflected back to the input region by dispersive region 232 or otherwise is −40 dB or less, −20 dB or less, −8 dB or less, or otherwise. It is appreciated that in other embodiments the power transmission, adverse power transmission, maximum power, or other performance characteristics may be different than the respective values discussed herein, but the structure of dispersive region 232 may change due to the intrinsic relationship between structure, functionality, and performance of demultiplexer 216.

FIG. 2B illustrates a vertical schematic or stack of various layers that are included in the illustrated embodiment of demultiplexer 216. However, it is appreciated that the illustrated embodiment is not exhaustive and that certain features or elements may be omitted to avoid obscuring certain aspects of the invention. In the illustrated embodiment, demultiplexer 216 includes substrate 234, dielectric layer 236, active layer 238 (e.g., as shown in the cross-sectional illustration of FIG. 2A), and a cladding layer 240. In some embodiments, demultiplexer 216 may be, in part or otherwise, a photonic integrated circuit or silicon photonic device that is compatible with conventional fabrication techniques (e.g., lithographic techniques such as photolithographic, electron-beam lithography and the like, sputtering, thermal evaporation, physical and chemical vapor deposition, and the like).

In one embodiment a silicon on insulator (SOI) wafer may be initially provided that includes a support substrate (e.g., a silicon substrate) that corresponds to substrate 234, a silicon dioxide dielectric layer that corresponds to dielectric layer 236, a silicon layer (e.g., intrinsic, doped, or otherwise), and a oxide layer (e.g., intrinsic, grown, or otherwise). In one embodiment, the silicon in the active layer 238 may be etched selectively by lithographically creating a pattern on the SOI wafer that is transferred to SOI wafer via a dry etch process (e.g., via a photoresist mask or other hard mask) to remove portions of the silicon. The silicon may be etched all the way down to dielectric layer 236 to form voids that may subsequently be backfilled with silicon dioxide that is subsequently encapsulated with silicon dioxide to form cladding layer 240. In one embodiment, there may be several etch depths including a full etch depth of the silicon to obtain the targeted structure. In one embodiment, the silicon may be 206 nm thick and thus the full etch depth may be 206 nm. In some embodiments, this may be a two-step encapsulation process in which two silicon dioxide depositions are performed with an intermediate chemical mechanical planarization used to yield a planar surface.

FIG. 2C illustrates a more detailed view of active layer 238 (relative to FIG. 2B) taken along a portion of periphery region 218 that includes input region 202 of FIG. 2A. In the illustrated embodiment, active layer 238 includes a first material 242 with a refractive index of ε₁ and a second material 244 with a refractive index of ε₂ that is different from ε₁. Homogenous regions of the first material 242 and the second material 244 may form waveguides or portions of waveguides that correspond to input region 202 and plurality of output regions 204 as illustrated in FIG. 2A and FIG. 2C.

FIG. 2D illustrates a more detailed view of active layer 238 (relative to FIG. 2B) taken along dispersive region 232. As described previously, active layer 238 includes a first material 242 (e.g., silicon) and a second material 244 (e.g., silicon dioxide) that are inhomogeneously interspersed to form a plurality of interfaces 246 that collectively form a material interface pattern. Each of the plurality of interfaces 246 that form the interface pattern correspond to a change in refractive index of dispersive region 232 to structure the dispersive region (i.e., the shape and arrangement of first material 242 and second material 244) to provide, at least in part, the functionality of demultiplexer 216 (i.e., optical separation of the plurality of distinct wavelength channels from the multi-channel optical signal and respective guidance of each of the plurality of distinct wavelength channels to the corresponding one of the plurality of output regions 204 when the input region 202 receives the multi-channel optical signal).

It is appreciated that in the illustrated embodiments of demultiplexer 216 as shown in FIG. 2A-FIG. 2D, the change in refractive index is shown as being vertically consistent (i.e., the first material 242 and second material 244 form interfaces that are substantially vertical or perpendicular to a lateral plane or cross-section of demultiplexer 216. However, in the same or other embodiments, the plurality of interfaces (e.g., interfaces 246 illustrated in FIG. 2D) may not be substantially perpendicular with the lateral plane or cross-section of demultiplexer 216.

FIG. 3A illustrates a more detailed cross-sectional view of a dispersive region of example photonic demultiplexer 300, in accordance with an embodiment of the present disclosure. FIG. 3B illustrates a more detailed view of an interface pattern formed by the shape and arrangement of a first material 310 and a second material 312 for the dispersive region of the photonic demultiplexer 300 of FIG. 3A. Photonic demultiplexer 300 is one possible implementation of optically active region 114 illustrated in FIG. 1 and demultiplexer 216 illustrated in FIG. 2A-FIG. 2D. One of skill in the art will recognize that the manipulation of incoming optical signals provided by the illustrated dispersive region into separate locations based on wavelength is an example of a manipulation that can be achieved through inverse design of the optically active region 114, and in other embodiments, inverse design can be used to design the optically active region 114 to perform other manipulations, including but not limited to directing signals toward photodetectors in a device configured to operate as a receiver as described in further detail below.

As illustrated in FIG. 3A and FIG. 3B, photonic demultiplexer 300 includes an input region 302, a plurality of output regions 304a-304d, and a dispersive region 306 optically disposed between input region 302 and plurality of output regions 304a-304d. Dispersive region 306 is surrounded, at least in part, by a peripheral region 308 that includes an inner boundary 314 and an outer boundary 316. It is appreciated that like named or labeled elements of photonic demultiplexer 300 may similarly correspond to like named or labeled elements of other demultiplexers described in embodiments of the present disclosure.

The first material 310 (i.e., black colored regions within dispersive region 306) and second material 312 (i.e., white colored regions within dispersive region 306) of photonic demultiplexer 300 are inhomogeneously interspersed to create a plurality of interfaces that collectively form material interface pattern 320 as illustrated in FIG. 3B. More specifically, an inverse design process that utilizes iterative gradient-based optimization, Markov Chain Monte Carlo optimization, or other optimization techniques combined with first principles simulations to generate a design that is substantially replicated by dispersive region 306 within a proportional or scaled manner such that photonic demultiplexer 300 provides the desired functionality. In the illustrated embodiment, dispersive region 306 is structured to optically separate each of a plurality of distinct wavelength channels from a multi-channel optical signal and respectively guide each of the plurality of distinct wavelength channels to a corresponding one of the plurality of output regions 304a-304d when the input region 302 receives the multi-channel optical signal. More specifically, the plurality of output regions 304a-304d are respectively mapped to wavelength channels having center wavelengths correspond to 1271 nm, 1291 nm, 1311 nm, and 1331 nm. In another embodiment, output regions 304a-304d are respectfully mapped to wavelength channels having center wavelengths that correspond to 1506 nm, 1514 nm, 1551 nm, and 1571 nm.

As illustrated in FIG. 3B, material interface pattern 320, which is defined by the black lines within dispersive region 306 and corresponds to a change in refractive index within dispersive region 306, includes a plurality of protrusions 322a-322b. A first protrusion 322a is formed of the first material 310 and extends from peripheral region 308 into dispersive region 306. Similarly, a second protrusion 322b is formed of the second material 312 and extends from peripheral region 308 into dispersive region 306. Further illustrated in FIG. 3B, dispersive region 306 includes a plurality of islands 324a-324b formed of either the first material 310 or the second material 312. The plurality of islands 324a-324b include a first island 324a that is formed of the first material 310 and is surrounded by the second material 312. The plurality of islands 324a-324b also includes a second island 324b that is formed of the second material 312 and is surrounded by the first material 310.

In some embodiments, material interface pattern 320 includes one or more dendritic shapes, wherein each of the one or more dendritic shapes are defined as a branched structure formed from first material 310 or second material 312 and having a width that alternates between increasing and decreasing in size along a corresponding direction. Referring back to FIG. 3A, for clarity, dendritic structure 318 is labeled with a white arrow having a black border. As can be seen, the width of dendritic structure 318 alternatively increases and decreases in size along a corresponding direction (i.e., the white labeled arrow overlaying a length of dendritic structure 318) to create a branched structure. It is appreciated that in other embodiments there may be no protrusions, there may be no islands, there may be no dendritic structures, or there may be any number, including zero, of protrusions, islands of any material included in the dispersive region 306, dendritic structures, or a combination thereof.

In some embodiments, the inverse design process includes a fabrication loss that enforces a minimum feature size, for example, to ensure fabricability of the design. In the illustrated embodiment of photonic demultiplexer 300 illustrated in FIG. 3A and FIG. 3B, material interface pattern 320 is shaped to enforce a minimum feature size within dispersive region 306 such that the plurality of interfaces within the cross-sectional area formed with first material 310 and second material 312 do not have a radius of curvature with a magnitude of less than a threshold size. For example, if the minimum feature size is 150 nm, the radius of curvature for any of the plurality of interfaces have a magnitude of less than the threshold size, which corresponds the inverse of half the minimum feature size (i.e., 1/75 nm⁻¹). Enforcement of such a minimum feature size prevents the inverse design process from generating designs that are not fabricable by considering manufacturing constraints, limitations, and/or yield. In the same or other embodiments, different or additional checks on metrics related to fabricability may be utilized to enforce a minimum width or spacing as a minimum feature size.

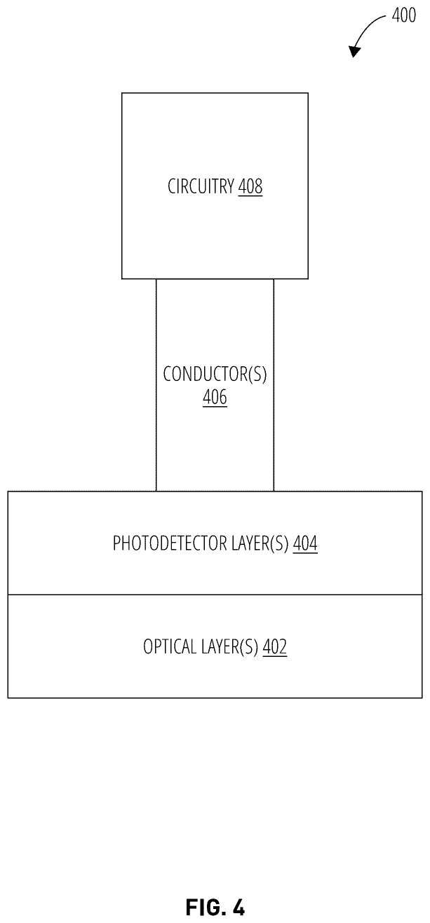

The multiplexer and demultiplexer illustrated and described above use the material interface pattern 320 within the optically active region 114 to manipulate the incident light to exhibit the desired dispersion behavior. Within the optically active region 114, the light may have greater intensity (e.g., field values) in some areas, and lesser intensity in other areas. In some embodiments, manipulation of the dispersion behavior of the incident light may be used to create highly performant optoelectronic receivers, with inverse design of both the optically active region 114 and the photodetector components being available to further improve performance. FIG. 4 is a schematic illustration of a non-limiting example embodiment of an optoelectronic receiver according to various aspects of the present disclosure. The illustration of the receiver 400 in FIG. 4 shows a logical relationship between the components, and does not necessarily show a physical layout of the device unless otherwise stated. The three-dimensional physical arrangement of the components illustrated in FIG. 4 is understood by one of ordinary skill in the art.

In the receiver 400, the optical layers 402 are arranged in a similar manner to the layers illustrated in FIG. 2B-FIG. 2D, with a substrate, a dielectric layer, an active layer (with an optically active region 114 having a material interface pattern 320 therein), and a cladding layer. Abutting or interspersed with the optical layers 402 are one or more photodetector layers 404. The photodetector layers 404 may include doped regions such as a p-type doped region, an n-type doped region, an i-type doped region, and/or any other type of semiconductor region suitable for creating an area capable of creating a charge in response to incident light, including the junctions between various doped regions. The photodetector layers 404 may be vertically stacked upon each other, interspersed with each other, arranged next to each other on the same vertical plane, or otherwise arranged in any other suitable configuration. In some embodiments, the photodetector layers 404 may be separate from the active layer 238 of the optical layers 402. In some embodiments, the photodetector layer 404 may be partially or completely interspersed within the active layer 238 of the optical layer 402. In some embodiments, the photodetector layers 404 are positioned within/under the cladding layer 240. In some embodiments, the photodetector layers 404 are at least partially within or outside of the cladding layer 240.

As illustrated, the receiver 400 also includes circuitry 408 that is coupled to the photodetector layers 404 via one or more conductors 406. The conductors 406 may include contact points and/or vias that contact the photodetector layers 404, and may also include bond wires, balls of a ball grid, traces, and/or other conductors that connect the contact points and/or vias to the circuitry 408. The circuitry 408 may include one or more transistors, logic gates, integrated circuits, and/or other circuitry that is configured to receive charge generated by the photodetector layers 404 via the conductors 406 and to extract a demodulated information signal therefrom.

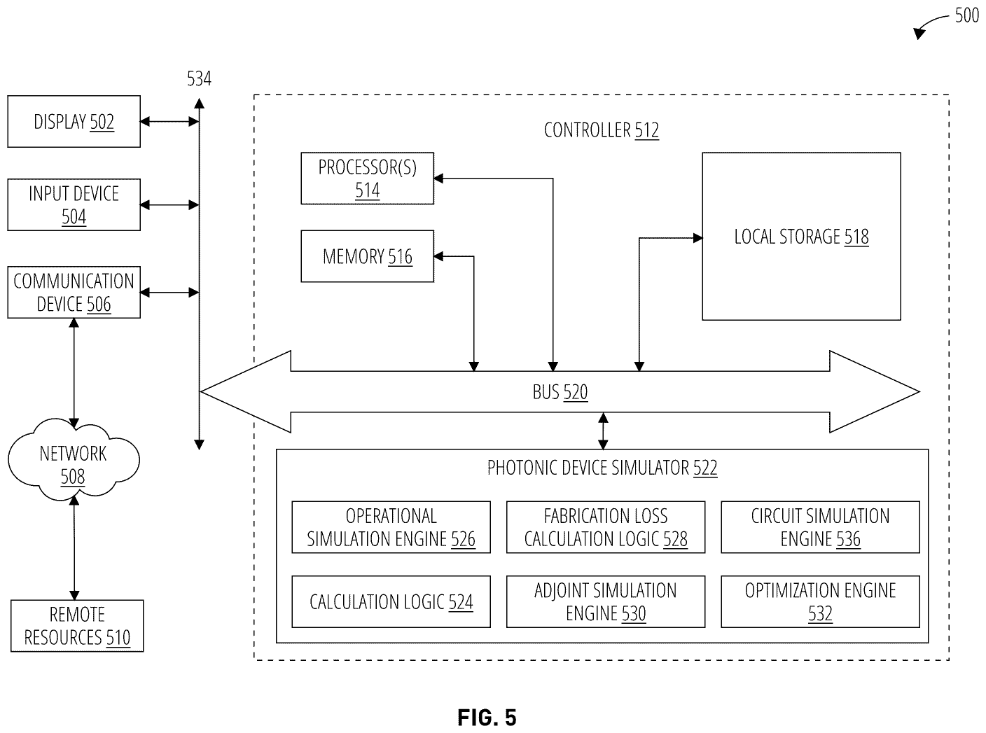

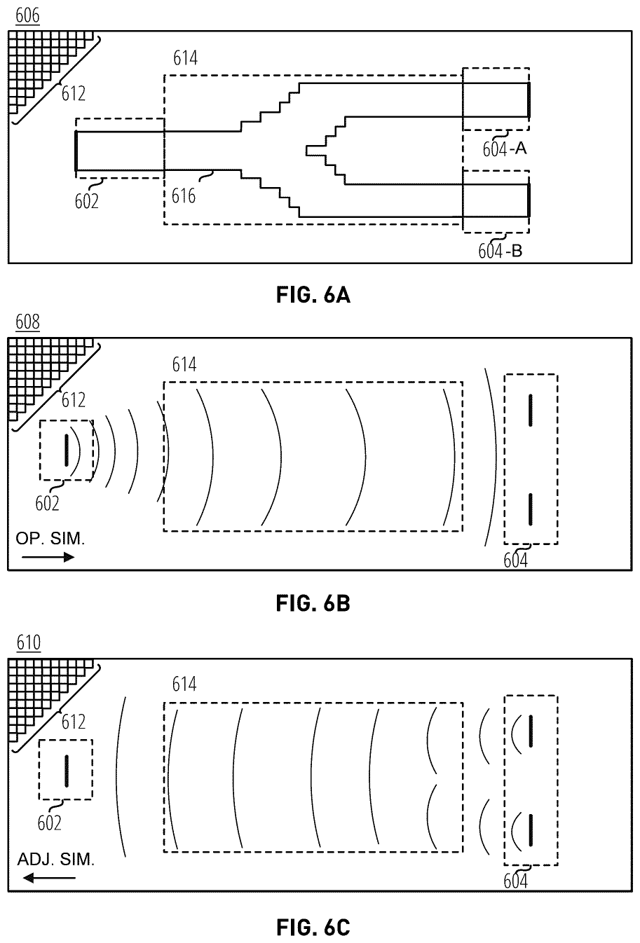

FIG. 5 is a functional block diagram illustrating a computing system 500 for generating a design of a photonic integrated circuit (i.e., photonic device), in accordance with an embodiment of the disclosure. Computing system 500 may be utilized to perform an inverse design process that generates a design with iterative gradient-based optimization that takes into consideration the underlying physics that govern the operation of the photonic integrated circuit and the related circuitry. More specifically, computing system 500 is a design tool that may be utilized to optimize structural parameters (e.g., shape and arrangement of a first material and a second material within the optically active region 114 of the embodiments described in the present disclosure) and circuit parameters (e.g., shape and location of p-n junctions, p-i-n junctions, contact points, vias, doped regions, etc.) of photonic integrated circuits based on first-principles simulations (e.g., electromagnetic simulations to determine a field response of the photonic device to an excitation source, circuit simulations to determine an electrical response to charges generated by the photodetector layers 404) and iterative gradient-based optimization. In other words, computing system 500 may provide a design obtained via the inverse design process that can be used to fabricate a receiver 400 as illustrated in FIG. 4.

As illustrated, computing system 500 includes controller 512, display 502, input device(s) 504, communication device(s) 506, network 508, remote resources 510, bus 534, and bus 520. Controller 512 includes processor 514, memory 516, local storage 518, and photonic device simulator 522. Photonic device simulator 522 includes operational simulation engine 526, fabrication loss calculation logic 528, calculation logic 524, adjoint simulation engine 530, circuit simulation engine 536, and optimization engine 532. It is appreciated that in some embodiments, controller 512 may be a distributed system. It is also appreciated that in some embodiments, the computing system 500 may include fewer than all of the components illustrated in FIG. 5. For example, the computing system 500 may be implemented solely by one or more computing devices configured to perform the actions attributed to controller 512.

Controller 512 is coupled to display 502 (e.g., a light emitting diode display, a liquid crystal display, and the like) coupled to bus 534 through bus 520 for displaying information to a user utilizing computing system 500 to optimize structural parameters of the photonic device (i.e., demultiplexer). Input device 504 is coupled to bus 534 through bus 520 for communicating information and command selections to processor 514. Input device 504 may include a mouse, trackball, keyboard, stylus, or other computer peripheral, to facilitate an interaction between the user and controller 512. In response, controller 512 may provide verification of the interaction through display 502.

Another device, which may optionally be coupled to controller 512, is a communication device 506 for accessing remote resources 510 of a distributed system via network 508. Communication device 506 may include any of a number of networking peripheral devices such as those used for coupling to an Ethernet, Internet, or wide area network, and the like. Communication device 506 may further include a mechanism that provides connectivity between controller 512 and the outside world. Note that any or all of the components of computing system 500 illustrated in FIG. 5 and associated hardware may be used in various embodiments of the present disclosure. The remote resources 510 may be part of a distributed system and include any number of processors, memory, and other resources for optimizing the structural parameters of the photonic device.

Controller 512 orchestrates operation of computing system 500 for optimizing structural parameters of the photonic device. Processor 514 (e.g., one or more central processing units, graphics processing units, and/or tensor processing units, etc.), memory 516 (e.g., volatile memory such as DRAM and SRAM, non-volatile memory such as ROM, flash memory, and the like), local storage 518 (e.g., magnetic memory such as computer disk drives), and the photonic device simulator 522 are coupled to each other through bus 520. Controller 512 includes software (e.g., instructions included in memory 516 coupled to processor 514) and/or hardware logic (e.g., application specific integrated circuits, field-programmable gate arrays, and the like) that when executed by controller 512 causes controller 512 or computing system 500 to perform operations. The operations may be based on instructions stored within any one of, or a combination of, memory 516, local storage 518, physical device simulator 522, and remote resources 510 accessed through network 508.

In the illustrated embodiment, the components of photonic device simulator 522 are utilized to optimize structural parameters and circuit parameters of the photonic device (e.g., optically active region 114 of FIG. 1, photodetector layers 404 and conductors 406 of FIG. 4). In some embodiments, computing system 500 may optimize the structural parameters and circuit parameters of the photonic device via, inter alia, simulations (e.g., operational and adjoint simulations) that utilize a finite-difference time-domain (FDTD) method, a finite-difference frequency-domain (FDFD) method, or any other suitable technique to model the field response (e.g., electric and magnetic fields within the photonic device) for the structural parameters, and other operational and adjoint simulations for the semiconductor behavior and circuitry of the photodetector layers 404, conductors 406, and circuitry 408, respectively. The operational simulation engine 526 provides instructions for performing an electromagnetic simulation of the photonic device operating in response to an excitation source within a simulated environment. In particular, the operational simulation determines a field response of the simulated environment (and thus the photonic device, which is described by the simulated environment) in response to the excitation source (e.g., based off an initial description or input design of the photonic device that describes the structural parameters of the photonic device within the simulated environment with a plurality of voxels). The structural parameters may correspond, for example, to the specific design, material compositions, dimensions, and the like of the optical layers 402. Fabrication loss calculation logic 528 provides instructions for determining a fabrication loss, which is utilized to enforce a minimum feature size to ensure fabricability. In some embodiments, the fabrication loss is also used to enforce binarization of the design (i.e., such that the photonic device includes a first material and a second material that are interspersed to form a plurality of interfaces). The circuit simulation engine 536 performs an operational simulation of the photodetector layers 404, conductors 406, and circuitry 408 based on the field response determined by the operational simulation engine 526 as input to the photodetector layers 404 in order to determine a performance metric. The circuit simulation engine 536 also performs an adjoint simulation of these features in order to backpropagate gradients to update the circuit parameters. Calculation logic 524 computes a loss metric determined via a loss function that incorporates a performance loss, based on the performance metric, and may also incorporate the fabrication loss. Adjoint simulation engine 530 is utilized in conjunction with the operational simulation engine 526 to perform an adjoint simulation of the photonic device to backpropagate the loss metric through the simulated environment via the loss function to determine how changes in the structural parameters of the photonic device influence the loss metric. Optimization engine 532 is utilized to update the structural parameters of the photonic device and the circuit parameters to reduce the loss metric and generate a revised description (i.e., revising the design) of the photonic device.

FIG. 6A-FIG. 6C respectively illustrate non-limiting example embodiments of an initial set up of a simulated environment 606 describing a photonic device, performing an operational simulation of the photonic device in response to an excitation source within the simulated environment 608, and performing an adjoint simulation of the photonic device within the simulated environment 610 according to various aspects of the present disclosure. The initial set up of the simulated environment, 1-dimensional representation of the simulated environment, operational simulation of the physical device, and adjoint simulation of the physical device may be implemented with computing system 500 illustrated in FIG. 5.

As illustrated in FIG. 6A-FIG. 6C, simulated environment is represented in two-dimensions. However, it is appreciated that other dimensionality (e.g., 3-dimensional space) may also be used to describe simulated environment and the photonic device. In some embodiments, optimization of structural parameters of the photonic device illustrated in FIG. 6A-FIG. 6C may be achieved via an inverse design process including, inter alia, simulations (e.g., operational simulations and adjoint simulations) that utilize a finite-difference time-domain (FDTD) method, a finite-difference frequency-domain (FDFD) method, or any other suitable technique to model the field response (e.g., electric and magnetic field) to an excitation source.

FIG. 6A illustrates a demonstrative simulated environment 606 describing a photonic integrated circuit (i.e., a photonic device such as a waveguide, receiver, demultiplexer, and/or the like), in accordance with a non-limiting example embodiment of the present disclosure. More specifically, in response to receiving an initial description of a photonic device defined by one or more structural parameters (e.g., an input design), a system (e.g., computing system 500 of FIG. 5) configures a simulated environment 606 to be representative of the photonic device. As illustrated, the simulated environment 606 (and subsequently the photonic device) is described by a plurality of voxels 612, which represent individual elements (i.e., discretized) of the two-dimensional (or other dimensionality) space. Each of the voxels 612 is illustrated as a two-dimensional square; however, it is appreciated that the voxels may be represented as cubes or other shapes in three-dimensional space. It is appreciated that the specific shape and dimensionality of the plurality of voxels 612 may be adjusted dependent on the simulated environment 606 and photonic device being simulated. It is further noted that only a portion of the plurality of voxels 612 are illustrated to avoid obscuring other aspects of the simulated environment 606.

Each of the plurality of voxels 612 may be associated with a structural value, a field value, and a source value. Collectively, the structural values of the simulated environment 606 describe the structural parameters of the photonic device. In one embodiment, the structural values may correspond to a relative permittivity, permeability, and/or refractive index that collectively describe structural (i.e., material) boundaries or interfaces of the photonic device (e.g., material interface pattern 320 of FIG. 3B). For example, an interface 616 is representative of where relative permittivity changes within the simulated environment 606 and may define a boundary of the photonic device where a first material meets or otherwise interfaces with a second material. The field value describes the field (or loss) response that is calculated (e.g., via Maxwell's equations) in response to an excitation source described by the source value. The field response, for example, may correspond to a vector describing the electric and/or magnetic fields (e.g., in one or more orthogonal directions) at a particular time step for each of the plurality of voxels 612. Thus, the field response may be based, at least in part, on the structural parameters of the photonic device and the excitation source.

In the illustrated embodiment, the photonic device corresponds to an optical demultiplexer having a design region 614 (e.g., corresponding to dispersive region 232 of FIG. 2A, and/or dispersive region 306 of FIG. 3A), in which structural parameters of the physical device may be updated or otherwise revised. More specifically, through an inverse design process, iterative gradient-based optimization of a loss metric determined from a loss function is performed to generate a design of the photonic device that functionally causes a multi-channel optical signal to be demultiplexed and guided from input port 602 to a corresponding one of the output ports 604. Thus, input port 602 (e.g., corresponding to input region 202 of FIG. 2A, input region 302 of FIG. 3A, and the like) of the photonic device corresponds to a location of an excitation source to provide an output (e.g., a Gaussian pulse, a wave, a waveguide mode response, and the like). The output of the excitation source interacts with the photonic device based on the structural parameters (e.g., an electromagnetic wave corresponding to the excitation source may be perturbed, retransmitted, attenuated, refracted, reflected, diffracted, scattered, absorbed, dispersed, amplified, or otherwise as the wave propagates through the photonic device within simulated environment 606). In other words, the excitation source may cause the field response of the photonic device to change, which is dependent on the underlying physics governing the physical domain and the structural parameters of the photonic device. The excitation source originates or is otherwise proximate to input port 602 and is positioned to propagate (or otherwise influence the field values of the plurality of voxels) through the design region 614 towards output ports 604 of the photonic device.

In the illustrated embodiment, the input port 602 and output ports 604 are positioned outside of the design region 614. In other words, in the illustrated embodiment, only a portion of the structural parameters of the photonic device is optimizable. However, in other embodiments, the entirety of the photonic device may be placed within the design region 614 such that the structural parameters may represent any portion or the entirety of the design of the photonic device. The electric and magnetic fields within the simulated environment 606 (and subsequently the photonic device) may change (e.g., represented by field values of the individual voxels that collectively correspond to the field response of the simulated environment) in response to the excitation source.

Though FIG. 6A illustrates the simulated environment 606 as including just features of the optically active region 114, it will be appreciated that the simulated environment 606 corresponds to the design region 702 for the photodetector layers 404 and conductors 406, as well, as will be discussed in further detail below.

The initial description of the photonic device, including initial structural parameters, excitation source, performance parameters or metrics, and other parameters describing the photonic device, are received by the system (e.g., computing system 500 of FIG. 5) and used to configure the simulated environment 606 for performing a first-principles based simulation of the photonic device. These specific values and parameters may be defined directly by a user (e.g., of computing system 500 in FIG. 5), indirectly (e.g., via controller 512 culling pre-determined values stored in memory 516, local storage 518, or remote resources 510), or a combination thereof.

FIG. 6B illustrates a non-limiting example embodiment of an operational optical simulation of the photonic device in response to an excitation source within simulated environment 608, in accordance with various aspects of the present disclosure. In the illustrated embodiment, the photonic device is an optical demultiplexer structured to optically separate each of a plurality of distinct wavelength channels included in a multi-channel optical signal received at input port 602 and respectively guide each of the plurality of distinct wavelength channels to a corresponding one of the plurality of output ports 604. The excitation source may be selected (randomly or otherwise) from the plurality of distinct wavelength channels and originates at input port 602 having a specified spatial, phase, and/or temporal profile. The operational optical simulation occurs over a plurality of time steps, including the illustrated time step. When performing the operational optical simulation, changes to the field response (e.g., the field value) for each of the plurality of voxels 612 are incrementally updated in response to the excitation source over the plurality of time steps. The changes in the field response at a particular time step are based, at least in part, on the structural parameters, the excitation source, and the field response of the simulated environment 610 at the immediately prior time step included in the plurality of time steps. Similarly, in some embodiments the source value of the plurality of voxels 612 is updated (e.g., based on the spatial profile and/or temporal profile describing the excitation source). It is appreciated that the operational optical simulation is incremental and that the field values (and source values) of the simulated environment 610 are updated incrementally at each time step as time moves forward for each of the plurality of time steps during the operational optical simulation. It is further noted that in some embodiments, the update is an iterative process and that the update of each field and source value is based, at least in part, on the previous update of each field and source value. It is still further noted that the output of the operational optical simulation (e.g., the field values) may be used as input for an operational circuit simulation, as described in further detail below.

FIG. 6C illustrates a non-limiting example embodiment of an adjoint simulation within simulated environment 610 by backpropagating a loss metric, in accordance with various aspects of the present disclosure. More specifically, the adjoint simulation illustrated in FIG. 6C is a time-backwards simulation in which a loss metric is treated as an excitation source that interacts with the photonic device and causes a loss response. In other words, an adjoint (or virtual source) based on the loss metric is placed at the output region (e.g., output ports 604) or other location that corresponds to a location used when determining the performance metric. The adjoint source(s) is then treated as a physical stimuli or an excitation source during the adjoint simulation. A loss response of the simulated environment 608 is computed for each of the plurality of time steps (e.g., backwards in time) in response to the adjoint source. The loss response collectively refers to loss values of the plurality of voxels 612 that are incrementally updated in response to the adjoint source over the plurality of time steps. The change in loss response based on the loss metric may correspond to a loss gradient, which is indicative of how changes in the field response of the physical device influence the loss metric. The loss gradient and the field gradient may be combined in the appropriate way to determine a structural gradient of the photonic device/simulated environment (e.g., how changes in the structural parameters of the photonic device within the simulated environment influence the loss metric). Once the structural gradient of a particular cycle (e.g., operational and adjoint simulation) is known, the structural parameters may be updated to reduce the loss metric and generate a revised description or design of the optical layers 402 of the photonic device. Along with the adjoint simulation of the optical layers 402, an adjoint simulation of the photodetector layers 404, conductors 406, and circuitry 408 is also performed in order to determine a circuit parameter gradient to be used to update the circuit parameters.

In some embodiments, iterative cycles of performing the operational simulation, and adjoint simulation, determining the structural gradient and circuit parameter gradient, and updating the structural parameters and circuit parameters to reduce the loss metric are performed successively as part of an inverse design process that utilizes iterative gradient-based optimization. An optimization scheme such as gradient descent may be utilized to determine specific amounts or degrees of changes to the structural parameters of the photonic device and the circuit parameters to incrementally reduce the loss metric. More specifically, after each cycle the structural parameters and circuit parameters are updated (e.g., optimized) to reduce the loss metric. The operational simulation, adjoint simulation, and updating the structural parameters are iteratively repeated until the loss metric substantially converges, is otherwise below or within a threshold value or range, or a predetermined number of iterations have been performed.

Previous inverse design techniques are highly effective in designing purely optical devices such as multiplexers and demultiplexers. However, the design of combined devices with electronic components (e.g., receivers with photodetectors and circuitry for demodulating received optical signals) faces additional technical problems. For example, performance of the photodetector layers 404 in response to the simulated field values within the optically active region 114, parasitics of the various conductors 406 coupling the photodetector layers 404 to the circuitry 408, and/or parasitics of the circuitry 408 itself may have effects on the overall performance of the physical device, which are not considered by a purely optical simulation. For example, the rate at which the photodetector layers 404 generate charge and parasitic losses induced by the conductors 406 may change the speed and accuracy at which values can be demodulated from the incoming signal by the circuitry 408. What is needed are techniques that allow highly responsive photodetectors to be designed by using inverse design techniques to design not only the optically active region 114, but also the photodetector layers 404 and/or the conductors 406, in order to increase the overall performance of the physical device. It may also be desirable to simulate additional portions of the system outside of the optically active region 114, including but not limited to the photodetector layers 404, the conductors 406, and/or the circuitry 408 in order to most accurately predict (and thereby improve) performance of the optimized design.

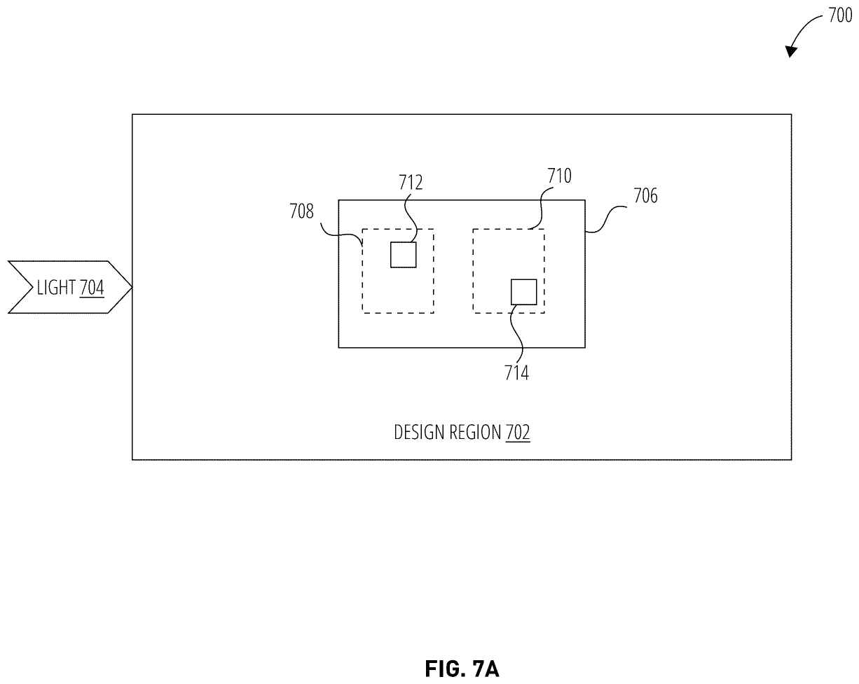

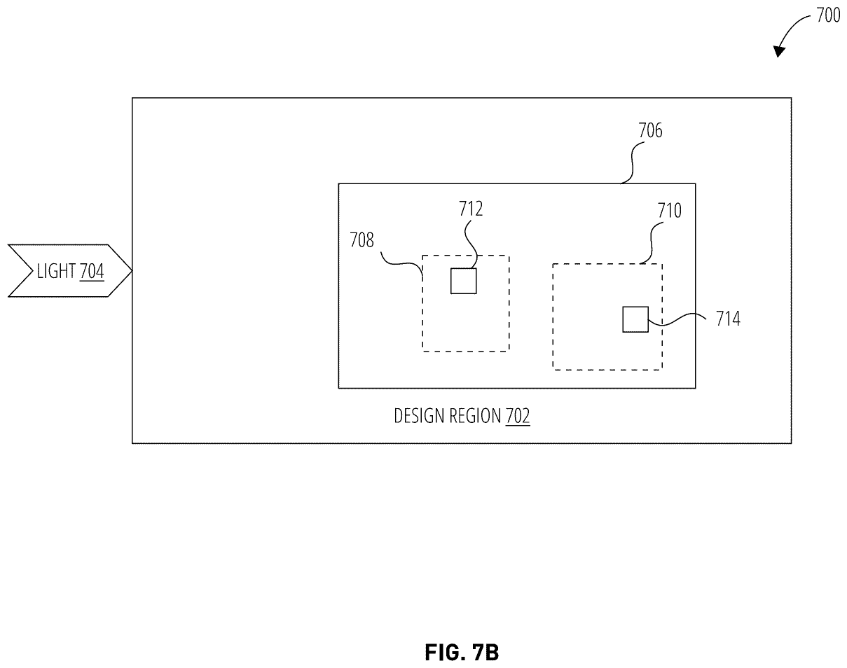

FIG. 7A-FIG. 7B are schematic illustrations of a design of a physical device such as an optoelectronic receiver to be optimized according to various aspects of the present disclosure. The receiver design 700 is a top-down view, similar to the simulated environments 606-610 illustrated in FIG. 6A-FIG. 6C, and the design region 702 of FIG. 7A and FIG. 7B may overlap in whole or in part with the design regions 614 of FIG. 6A-FIG. 6C. The details of design region 614 are not illustrated in FIG. 7A and FIG. 7B to avoid obscuring the other features illustrated therein.

As shown, the receiver design 700 is configured such that a stimulus, such as light 704, is provided to the optically active region 114 within the design region 702 (e.g., via input port 602 illustrated in FIG. 6A-FIG. 6C). In addition to the optically active region 114 illustrated and discussed previously, the receiver design 700 includes designs for photodetector layers 404, such as a p region 706, a first n region 708, and a second n region 710. The designs for the photodetector layers 404 may be specified as a pattern of voxels, as one or more polygons or other two-dimensional or three-dimensional geometric shapes, and/or using any other suitable technique, which are represented as one or more parameters. Though a single p-doped region and two n-doped regions are illustrated, this illustration is used for the sake of simplicity. In some embodiments, more complicated designs that include a different number of p regions, a different number of n regions, and/or regions for a different photodetector layer 404 (e.g., an i-doped layer) may be used. Further, though illustrated as separate layers, in some embodiments, the p-doped regions, n-doped regions, and/or other doped regions for generating charge based on incident light may be vertically interlaced with each other and/or with the optically active region 114.

As shown, the receiver design 700 also includes a first contact point 712 and a second contact point 714. The first contact point 712 and second contact point 714 are part of the conductors 406 carry charge from the photodetector layers 404 to the circuitry 408, and the receiver design 700 includes parameters specifying a size, shape, and location for the first contact point 712 and second contact point 714. In some embodiments, the size, shape, and location of other portions of the conductors 406, including but not limited to vias, traces, wires, and/or other conductors 406, may also be part of the receiver design 700, but are not shown in FIG. 7A or FIG. 7B for the sake of clarity. In some embodiments, the location and contents of the circuitry 408 may also be provided as mutable parts of the receiver design 700, but again are not illustrated for the sake of clarity.

The circuit parameters specify the size, shape, and location of the p region 706, first n region 708, second n region 710, first contact point 712, and second contact point 714. During iterations of the optimization process, the circuit parameters may be adjusted to change the size, shape, and/or location of these components. For example, FIG. 7B illustrates that the p region 706 and second n region 710 have been enlarged, and the first n region 708, the second n region 710, the first contact point 712, and the second contact point 714 have been moved in comparison to FIG. 7A. The optimization process may make these changes in order to improve the functioning of the optoelectronic receiver as a whole, as described in further detail below. The optimization process may also add, remove, combine, or split doped regions, contact points, vias, traces, wires, or other components specified by the circuit parameters.

Though FIG. 7A and FIG. 7B are two-dimensional top-down illustrations, it will be appreciated that the circuit parameters may include two-dimensional parameters or three-dimensional parameters (e.g., the shapes of doped regions and/or conductors may be specified in two or three dimensions). Further, the circuit parameters may be translated to polygons that are provided to a fabrication system for fabrication of the physical device. As such, the polygons may represent different dopants in a single vertical layer, different dopants in overlapping layers, and/or may overlap with each other such that multiple dopants are applied to the same voxels (depending on the design rules of the fabrication system).

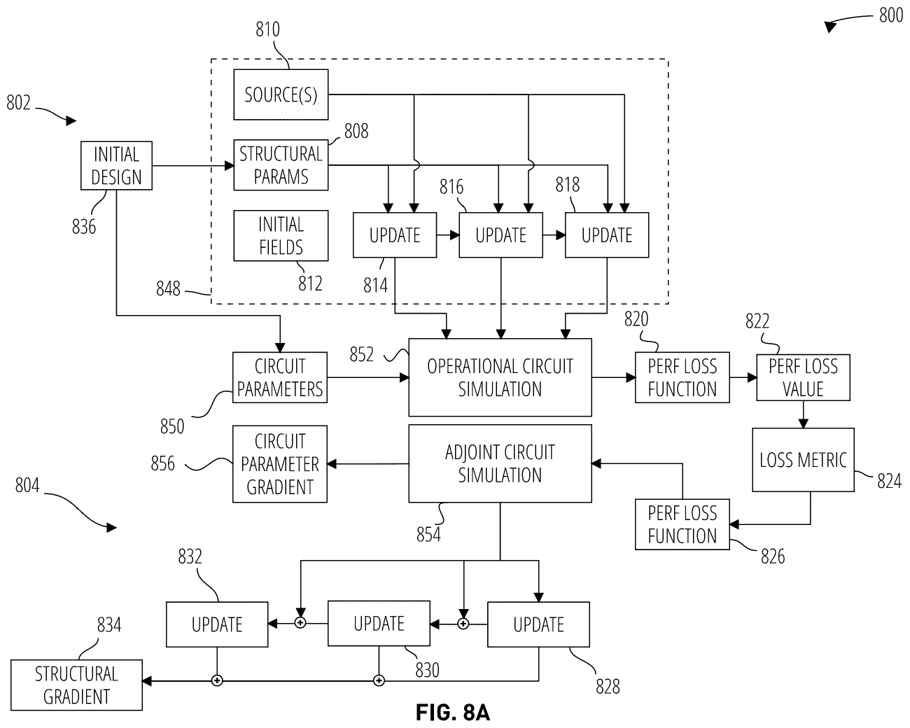

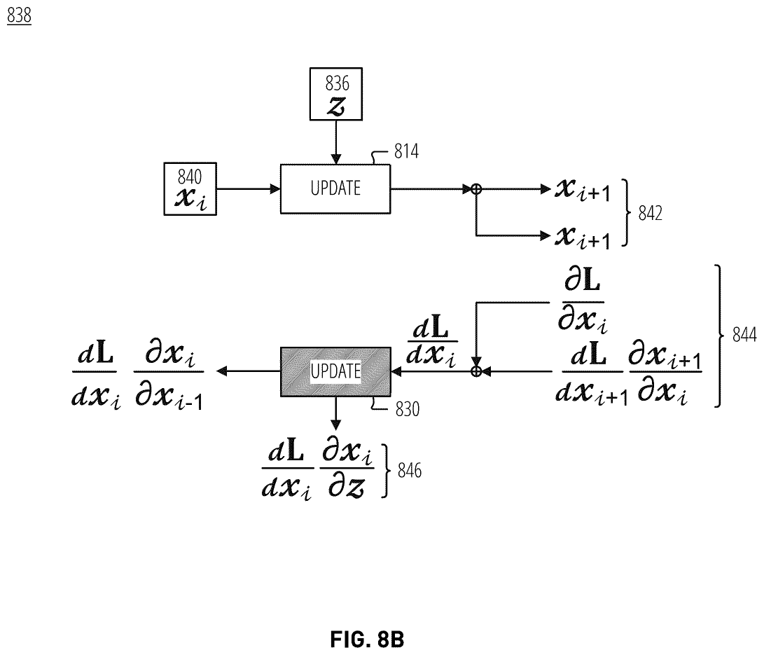

FIG. 8A is a flow chart 800 illustrating example time steps for an operational simulation 802 and an adjoint simulation 804, in accordance with various aspects of the present disclosure. Flow chart 800 is one possible implementation that a system may use to perform the operational simulation 802 and adjoint simulation 804 of the simulated environment describing a photonic integrated circuit and related circuitry (e.g., an optoelectronic receiver) illustrated above. In the illustrated embodiment, the operational simulation 802 utilizes a finite-difference time-domain (FDTD) method to model the field response (both electric and magnetic) or loss response at each of a plurality of voxels for a plurality of time steps in response to physical stimuli corresponding to an excitation source and/or adjoint source, and uses a circuit simulation engine 536 to model the operation of the photodetector layers 404, conductors 406, and circuitry 408 in response to the simulated field values at the voxels.

An initial design 836 is determined that includes structural parameters and circuit parameters for a physical device such as a photonic device to be simulated. In some embodiments, the initial design 836 may include a plurality of geometric shape primitives, voxel patterns, or other parameters that define the structural parameters for the optically active region 114 and the circuit parameters for the photodetector layer 404, conductor 406, and circuitry 408. In some embodiments, the structural parameters and circuit parameters may be initialized to default or random values in order to avoid biasing the eventual outcome of the design process. In some embodiments, the initial design 836 may be based on a design specification that includes performance goals for the physical device, design constraints for the physical device (e.g., a size and/or shape of the design region 614, a location of one or more input ports 602, a location and/or design for the circuitry 408 in relation to the design region 614, etc.), starting settings for various aspects of the structural parameters and/or circuit parameters (e.g., an initial number of geometric shape primitives to specify features within the design region 614, an initial number of contact points and/or doped regions, etc.), initial structural parameters and/or circuit parameters to be used, and/or any other relevant aspect of the design and/or optimization to be performed for the physical device.

After determining the initial design 836, the operational simulation 802 provides structural parameters 808 from the initial design 836 for an operational simulation of the optically active region 114, and circuit parameters 850 from the initial design 836 for an operational simulation of the photodetector layers 404, conductors 406, and circuitry 408. An operational optical simulation 848 occurs over a plurality of time-steps (e.g., from an initial time step to a final time step over a pre-determined or conditional number of time steps having a specified time step size) and models changes (e.g., from the initial field values 812) in electric and magnetic fields of a plurality of voxels describing the simulated environment and/or photonic device that collectively correspond to the field response. More specifically, update operations (e.g., update operation 814, update operation 816, and update operation 818) are iterative and based on the field response, structural parameters 808 (that is, for a selected one of the perturbed structural parameters 806), and one or more excitation sources 810. Each update operation is succeeded by another update operation, which are representative of successive steps forward in time within the plurality of time steps. For example, update operation 816 updates the field values 840 (see, e.g., FIG. 8B) based on the field response determined from the previous update operation 814, excitation sources 810, and the structural parameters 808. Similarly, update operation 818 updates the field values 842 (see, e.g., FIG. 8B) based on the field response determined from update operation 816. In other words, at each time step of the operational simulation the field values (and thus field response) are updated based on the previous field response and structural parameters of the photonic device.

In some embodiments, the simulated behavior of the one or more excitation sources 810 may change over time. For example, the one or more excitation sources 810 may be simulated to generate a first signal that indicates a first logical value (e.g., a digital 1), transition to generating a second signal that indicates a second logical value (e.g., a digital 0), and back to generating the first signal that indicates the first logical value over time. In some embodiments, the first signal and second signal may have different wavelengths, amplitudes, phases, or other characteristics. In some embodiments, the first signal may represent providing optical energy to the input port 602, while the second signal may represent refraining from providing optical energy to the input port 602. A clock speed at which the simulation changes the one or more excitation sources 810 from generating the first signal to the second signal and back may be provided in the design specification. The design specification may also provide a pattern at which the signal should be changed (e.g., alternating directly between the first signal and second signal on consecutive clock cycles, simulating the first signal or the second signal on multiple consecutive clock cycles in a row before switching, etc.).

As the operational optical simulation 848 is being performed, the field values (e.g., electric and magnetic field values) computed at each of the voxels of the simulated environment 608 are provided as input to the operational circuit simulation 852. In some embodiments, the operational circuit simulation 852 is updated at each time step. In some embodiments, the operational circuit simulation 852 may be updated periodically (e.g., once every n time steps, where n is greater than 1).

The operational circuit simulation 852 uses a semiconductor simulator configured to take into account the dopant concentrations (P and N distributions, and/or other dopants) within the voxels of the photodetector layers 404 as indicated by the circuit parameters, determine drift diffusion equation solutions, and/or perform other tasks to simulate an amount of charge generated by the photodetector layers 404 in response to the field values simulated in the voxels of the optically active region 114. Any suitable semiconductor simulator may be used, including but not limited to COMSOL provided by COMSOL, Inc., DEVSIM provided by DEVSIM LLC, Synopsis provided by Synopsys, Inc., or any other semiconductor simulator.

In addition to determining the charge generated the photodetector layers 404, the operational circuit simulation 852 also simulates the remainder of the conductors 406 and circuitry 408 based on the relevant circuit parameters (e.g., the size, shape, and locations of the contact points, vias, traces, wires, and/or other conductors 406), in order to determine how the overall physical device will react in response to the signals received from the one or more excitation sources 810. For example, the operational circuit simulation 852 may take into account models for parasitic inductance of various portions of the conductors 406 (e.g., bond wires, ball grid elements, traces, wires, etc.) and the circuitry 408 itself in determining the charge delivered from the photodetector layers 404 to the circuitry 408. In some embodiments, the operational circuit simulation 852 may simulate the functioning of the circuitry 408 in response to the charge to generate a predicted output (e.g., demodulated signals). Any suitable circuit simulator, including but not limited to SPICE from the University of California at Berkeley, may be used to simulate the performance of the conductors 406 and the circuitry 408 to generate the predicted output.

Once the final time step of the operational simulation 802 is performed, a performance loss function 820 is used to determine a performance loss value 822. Any suitable performance loss function 820 and performance loss value 822 may be used. Typically, a measurement of the charge received by the circuitry 408 is used by the performance loss function 820. In some embodiments, in order to optimize the demodulation performance of the combined physical device, a measurement of the demodulation calculated by the operational circuit simulation 852 may be performed by the performance loss function 820, and a comparison of this measurement to a desired measurement may be used as the performance loss value 822.

One non-limiting example of a technique that may be used to measure demodulation performance is to determine and measure an eye diagram representing the performance calculated by the operational circuit simulation 852. The performance loss function 820 may compare the eye diagram to a desired eye diagram provided in the design specification, or may measure aspects of the eye diagram and attempt to maximize performance of the measured aspects.

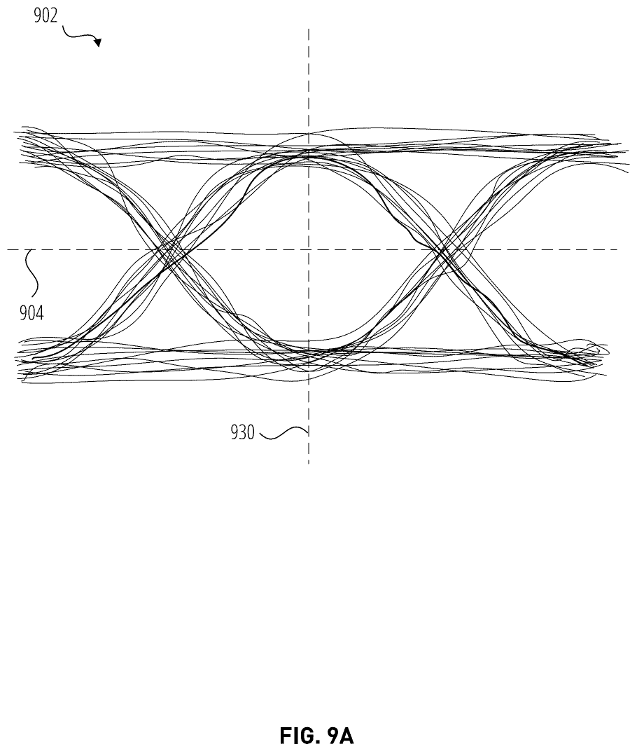

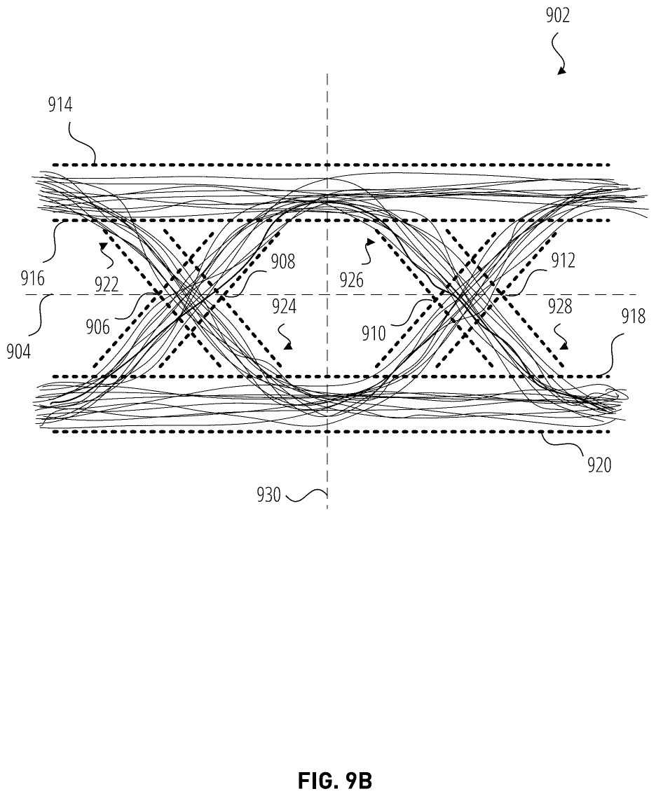

FIG. 9A illustrates a non-limiting example embodiment of an eye diagram according to various aspects of the present disclosure. The eye diagram 902 illustrates signal values received at the circuitry 408, as determined by the operational circuit simulation 852 in response to the field values determined by the operational optical simulation 848. One of skill in the art will recognize the format of the eye diagram 902, wherein signals received during multiple clock cycles are overlaid atop each other, with a sampling point 930 representing a point in the clock cycle at which the circuitry 408 may determine the logical value. A zero line 904 represents a middle of a range of voltage values sensed, with a first logical value being represented by values above the zero line 904, and a second logical value being represented by values below the zero line 904. Depending on the clock cycle, the signal either stays at its existing logical value, transitions from one logical value to the other, or transitions from one logical value too the other and back. While the eye diagram 902 illustrates two logical states, in some embodiments, more logical states may be present, and the eye diagram 902 may illustrate more than one clock cycle.

FIG. 9B adds annotations to the eye diagram 902 in bold dashed lines to indicate features that may be measured by the performance loss function 820 that reflect potential demodulation performance of the physical device. A distance between a first line 914 and a second line 916 indicates an amount of distortion at a first logical value, and a distance between a third line 918 and a fourth line 920 indicates an amount of distortion at a second logical value. A distance between a first point 906 and a second point 908, and a distance between a third point 910 and a fourth point 912, indicate an amount of jitter, or an amount at which various clock cycles of the signal are different lengths compared to each other. A distance between the second line 916 and the zero line 904, and/or between the third line 918 and the zero line 904, represents a signal-to-noise ratio at the sampling point 930. A slope of the transitions (i.e., the region between the first transition line 922 and the second transition line 924 that indicates a transition from the first logical value to the second logical value, and the region between the third transition line 926 and the fourth transition line 928 that indicates a transition from the second logical value to the first logical value) indicates an amount of time it takes to transition between the logical values.

The performance loss function 820 may measure any desired aspect of the eye diagram 902 to compare it to a desired value for optimization. For example, the performance loss function 820 may measure the slope of the transitions, and may optimize to increase the slope of the transitions so that the physical device can successfully operate at greater clock rates for incoming signals. As another example, the performance loss function 820 may measure the distances between the second line 916 and the zero line 904, and between the zero line 904 and the third line 918, in order to increase the distances and thereby improve the signal-to-noise ratio. These examples should not be seen as limiting, and in other embodiments, the performance loss function 820 may measure other aspects of the eye diagram 902. Further, the use and measurement of an eye diagram 902 should not be seen as limiting. In other embodiments, different analyses of the signals generated by the photodetector layers 404, including but not limited to a BERT scan, may be used.

Returning to FIG. 8A, the performance loss value 822 is converted into a loss metric 824. The loss metric 824 is a value to be minimized that represents at least a difference between the simulated performance of the physical device and the desired performance of the physical device. In some embodiments, additional factors may be included in the loss metric 824, including but not limited to one or more of a measure of the fabricability of the physical device, a measure of heat generated by the physical device, an amount of power lost or used by the physical device, or any other aspect of the physical device that it is desired to be optimized.

From the loss metric 824, a gradient of the performance loss function may be determined at block 826. The gradient determined from block 826 is treated as an adjoint input to the circuit simulation, and an adjoint circuit simulation 854 is performed. In some embodiments, if a differentiable simulator is used for the operational circuit simulation 852, the gradient provided by the differentiable simulator may be used for the adjoint circuit simulation 854. The adjoint circuit simulation 854 produces a circuit parameter gradient 856, which indicates changes to be made to the circuit parameters in order to improve performance of the physical device, given the simulated field values.

The result of the adjoint circuit simulation 854, in turn, may be backpropagated in reverse (from the final time step incrementally through the plurality of time steps until reaching the initial time step via update operation 828, update operation 832, and update operation 830) to determine structural gradient 834 that indicates changes to be made to the structural parameters 808 to further improve performance.

In the illustrated embodiment, the operational simulation 802 (e.g., operational circuit simulation 852 and the operational optical simulation 848) and the adjoint simulation 804 (e.g., the adjoint circuit simulation 854 and the adjoint simulation 804) are described pictorially, from a high-level, using “update” and “loss” operations as well as their corresponding gradient operations. The simulation is set up initially in which the structural parameters, circuit parameters, physical stimuli (i.e., excitation source), and initial field states of the simulated environment (and photonic device) are provided (e.g., via an initial description and/or input design). As discussed previously, the field values are updated in response to the excitation source based on the structural parameters. More specifically, the update operation is given by ϕ, where [symbol] =ϕ [symbol] , [symbol] ,z) for [symbol] =1, . . . [symbol] . Here, [symbol] corresponds to the total number of time steps (e.g., the plurality of time steps) for the operational simulation, where [symbol] corresponds to the field response (the field value associated with the electric and magnetic fields of each of the plurality of voxels) of the simulated environment at time step [symbol] , [symbol] corresponds to the excitation source(s) (the source value associated with the electric and magnetic fields for each of the plurality of voxels) of the simulated environment at time step [symbol] , and z corresponds to the structural parameters describing the topology and/or material properties of the physical device (e.g., relative permittivity, index of refraction, and the like).

It is noted that using the FDTD method, the update operation may specifically be stated as:

$$ϕ ( , , 𝓏 ) = A ( 𝓏 ) + B ( 𝓏 )$$

That is to say the FDTD update is linear with respect to the field and source terms. Concretely, A(z)∈ [symbol] ^{N×N} and B(z)∈ [symbol] ^{N×N} are linear operators which depend on the structure parameters, z, and act on the fields, [symbol] , and the sources, [symbol] , respectively. Here, it is assumed that [symbol] , [symbol] ∈ [symbol] ^{N} where N is the number of FDTD field components in the operational simulation. Additionally, the loss operation (e.g., loss function) may be given by L=ƒ( [symbol] , . . . , [symbol] ), which takes as input the eye diagram (and/or other measurements of performance or fitness) and produces a single, real-valued scalar (e.g., the loss metric) that can be reduced and/or minimized.

In terms of revising or otherwise optimizing the structural parameters of the physical device, the relevant quantity to produce is dL/dz, which is used to describe the influence of changes in the structural parameters of the initial design 836 on the loss value and is denoted as the structural gradient 834 illustrated in FIG. 8A. A similar representation may be used to denote the circuit parameter gradient 856.

FIG. 8B is a chart 838 illustrating the relationship between the update operation for the operational simulation and the adjoint simulation (e.g., backpropagation), in accordance with an embodiment of the present disclosure. More specifically, FIG. 8B summarizes the operational and adjoint simulation relationships that are involved in computing the structural gradient, dL/dz, which include

$$\frac{\partial L}{\partial {x}_{i}} , \frac{\partial {x}_{i + 1}}{\partial {x}_{i}} , \frac{d L}{d {x}_{i}} , and \frac{\partial {x}_{i}}{\partial z} .$$

Additional terms may be added to represent the circuit parameter gradient 856.

The update operation 816 of the operational simulation 802 updates the field values 840, [symbol] , of the plurality of voxels at the [symbol] th time step to the next time step (i.e., [symbol] +1 time step), which correspond to the field values 842, [symbol] . The gradients 844 are utilized to determine

$$\frac{\partial L}{\partial {x}_{i}}$$

for the backpropagation (e.g., update operation 832 backwards in time), which combined with the gradients 846 are used, at least in part, to calculate the structural gradient, dL/dz.

$$\frac{\partial L}{\partial {x}_{i}}$$

is the contribution of each field to the loss metric, L. It is noted that this is the partial derivative, and therefore does not take into account the causal relationship of [symbol] → [symbol] . Thus,

$$\frac{\partial {x}_{i + 1}}{\partial {x}_{i}}$$

is utilized which encompasses the [symbol] → [symbol] relationship. The loss gradient,

$$\frac{dL}{{dx}_{i}} ,$$

may also be used to compute the structural gradient, dL/dz, and corresponds to the total derivative of the field with respect to loss value, L. The loss gradient,

$$\frac{dL}{{dx}_{i}} ,$$

at a particular time step, [symbol] , is equal to the summation of

$$\frac{\partial L}{\partial {x}_{i}} + \frac{dL}{{dx}_{i + 1}} \frac{\partial {x}_{i + 1}}{\partial {x}_{i}} .$$

### Finally,

$$\frac{\partial {x}_{i}}{\partial z} ,$$

which corresponds to the field gradient, is used which is the contribution to dL/dz from each time/update step.

In particular, the memory footprint to directly compute

$$\frac{\partial L}{\partial {x}_{i}}$$

and dL/dz is so large that it is difficult to store more than a handful of state Tensors. The state Tensor corresponds to storing the values of all of the FDTD cells (e.g., the plurality of voxels) for a single simulation time step. It is appreciated that the term “tensor” may refer to tensors in a mathematical sense or as described by the TensorFlow framework developed by Alphabet, Inc. In some embodiments the term “tensor” refers to a mathematical tensor which corresponds to a multidimensional array that follows specific transformation laws. However, in most embodiments, the term “tensor” refers to TensorFlow tensors, in which a tensor is described as a generalization of vectors and matrices to potentially higher dimensions (e.g., n-dimensional arrays of base data types), and is not necessarily limited to specific transformation laws. For example, for the general loss function ƒ, it may be desired to store the fields, [symbol] , for all time steps, [symbol] . This is because, for most choices of ƒ, the gradient will be a function of the arguments of ƒ. This difficulty is compounded by the fact that the values of

$$\frac{\partial L}{\partial {x}_{i}}$$

for larger values of [symbol] are needed before the values for smaller [symbol] due to the incremental updates of the field response and/or through backpropagation of the loss metric, which may prevent the use of schemes that attempt to store only the values

$$\frac{\partial L}{\partial {x}_{i}} ,$$

at an immediate time step.

An additional difficulty is further illustrated when computing the structural gradient, dL/dz, which is given by:

$$\frac{dL}{dz} = {\sum }_{i} \frac{dL}{{dx}_{i}} \frac{\partial {x}_{i}}{\partial z} .$$

For completeness, the full form of the first term in the sum, dL/dz, is expressed as:

$$\frac{dL}{{dx}_{i}} = \frac{\partial L}{\partial {x}_{i}} + \frac{dL}{{dx}_{i + 1}} \frac{\partial {x}_{i + 1}}{\partial {x}_{i}}$$

Based on the definition of ϕ as described by equation (1), it is noted that

$$\frac{\partial {x}_{i + 1}}{\partial {x}_{i}} = A ( z ) ,$$

which can be substituted in equation (3) to arrive at an adjoint update for backpropagation (e.g., the update operations such as update operation 832), which can be expressed as:

$$\frac{dL}{{dx}_{i}} = \frac{\partial L}{\partial {x}_{i}} + \frac{dL}{{dx}_{i + 1}} A ( z ) ,$$

$$or$$

$${∇}_{{x}_{i}} L = {A ( z )}^{T} {∇}_{{x}_{i + 1}} L + \frac{\partial {L}^{T}}{\partial {x}_{i}}$$

The adjoint update is the backpropagation of the loss gradient (e.g., from the loss metric) from later to earlier time steps and may be referred to as a backwards solve for

$$\frac{dL}{{dx}_{i}} .$$

More specifically, the loss gradient may initially be based upon the backpropagation of a loss metric determined from the operational simulation with the loss function. The second term in the sum of the structural gradient, dL/dz, corresponds to the field gradient and is denoted as:

$$\frac{\partial {x}_{i}}{\partial z} = \frac{d ϕ ( {x}_{i - 1} , {i - 1}_{} , z )}{dz} = \frac{dA ( z )}{dz} {x}_{i - 1} + \frac{dB ( z )}{dz} {i - 1}_{} ,$$

for the particular form of ϕ described by the first equation above. Thus, each term of the sum associated dL/dz depends on both

$$\frac{dL}{{dx}_{{i}_{0}}}$$

for [symbol] >= [symbol] ₀ and xᵢ_{₀} for [symbol] < [symbol] ₀. Since the dependency chains of these two terms are in opposite directions, it is concluded that computing dL/dz in this way utilizes the storage of xᵢ values for all of [symbol] . In some embodiments, the need to store all field values may be mitigated by a reduced representation of the fields.

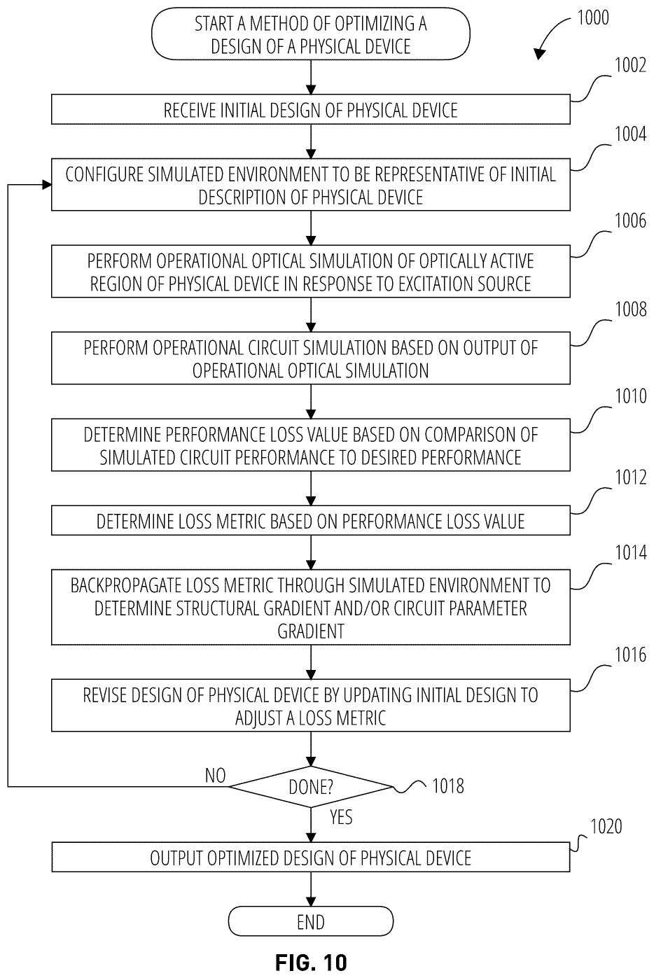

FIG. 10 is a flowchart that illustrates a non-limiting example embodiment of a method for generating a design of physical device such as a photonic integrated circuit, in accordance with various aspects of the present disclosure. It is appreciated that method 1000 is an inverse design process that may be accomplished by performing operations with a system to perform iterative gradient-based optimization of a loss metric determined from a loss function that includes at least a performance loss. In the same or other embodiments, method 1000 may be included as instructions provided by at least one machine-accessible storage medium (e.g., non-transitory memory) that, when executed by a machine or a collection of machines (e.g., computing system 500), will cause the machine(s) to perform operations for generating and/or improving the design of the photonic integrated circuit. It is further appreciated that the order in which some or all of the process blocks appear in method 1000 should not be deemed limiting. Rather, one of ordinary skill in the art having the benefit of the present disclosure will understand that some of the process blocks may be executed in a variety of orders not illustrated, or even in parallel.

From a start block, the method 1000 proceeds to block 1002, where an initial design 836 of a physical device such as a photonic integrated circuit is received. In some embodiments, the physical device may be expected to have a certain functionality (e.g., perform as an optoelectronic receiver 400) after optimization. The initial design 836 may describe structural parameters of the physical device within a simulated environment. The simulated environment may include a plurality of voxels that collectively describe the structural parameters of an optically active region 114 of the physical device. Each of the plurality of voxels is associated with a structural value to describe the structural parameters, a field value to describe the field response (e.g., the electric and magnetic fields in one or more orthogonal directions) to physical stimuli (e.g., one or more excitation sources), and a source value to describe the physical stimuli. The initial design 836 may also describe circuit parameters (e.g., shape and location of p-n junctions, p-i-n junctions, contact points, vias, doped regions, etc.) to be simulated.

In some embodiments the initial design 836 may be a first description of the physical device in which values for the structural parameters and circuit parameters may be random values or null values such that there is no bias for the initial (e.g., first) design. It is appreciated that the initial description or input design may be a relative term. Thus, in some embodiments an initial description may be a first description of the physical device described within the context of the simulated environment (e.g., a first input design for performing a first operational simulation).

However, in other embodiments, the term initial description may refer to an initial description of a particular cycle (e.g., of performing an operational simulation 802, operating an adjoint simulation 804, and updating the structural parameters and circuit parameters). In such an embodiment, the initial design 836 or design of that particular cycle may correspond to a revised description or refined design (e.g., generated from a previous cycle). In some embodiments, the simulated environment includes a design region that includes a portion of the plurality of voxels which have structural parameters that may be updated, revised, or otherwise changed to optimize the structural parameters of the physical device, and that coincides with design region 702 for the photodetector layers 404, conductors 406, and circuitry 408. In the same or other embodiments, the structural parameters are associated with geometric boundaries and/or material compositions of the physical device based on the material properties (e.g., relative permittivity, index of refraction, etc.) of the simulated environment.

At block 1004, a simulated environment is configured to be representative of the initial description (e.g., the structural parameters and circuit parameters based on the initial design) of the physical device. Once the structural parameters and circuit parameters have been received or otherwise obtained, the simulated environment is configured (e.g., the number of voxels, shape/arrangement of voxels, and specific values for the structural value, field value, and/or source value of the voxels are set based on the structural parameters; and the doped regions of the photodetector layers 404, the size, shape, and location of contact points/vias and other conductors 406 are set based on the circuit parameters). In some embodiments the simulated environment includes a design region (i.e., the optically active region 114) optically coupled to at least a first communication region. In some embodiments, the first communication region may correspond to an input region or port (e.g., where an excitation source originates).

Block 1006 illustrates performing an operational optical simulation of the optically active region 114 of the physical device within the simulated environment operating in response to one or more excitation sources. More specifically, in some embodiments an electromagnetic simulation is performed in which a field response of the photonic integrated circuit is updated incrementally over a plurality of time steps to determine how the how the field response of the physical device changes due to the excitation source. The field values of the plurality of voxels are updated in response to the excitation source and based, at least in part, on the structural parameters of the optically active region 114. Additionally, each update operation at a particular time step may also be based, at least in part, on a previous (e.g., immediately prior) time step. Further, the action of the excitation source may change over time (e.g., representing modulation between a signal representing a first logical value and a signal representing a second logical value).

Consequently, the operational optical simulation simulates an interaction between the photonic device (i.e., the optically active region 114) and a physical stimuli (i.e., one or more excitation sources) to determine simulated field values within the optically active region 114 in response to the physical stimuli. The interaction may correspond to any one of, or combination of a perturbation, retransmission, attenuation, dispersion, refraction, reflection, diffraction, absorption, scattering, amplification, or otherwise of the physical stimuli within electromagnetic domain due, at least in part, to the structural parameters of the photonic device and underlying physics governing operation of the photonic device. Thus, the operational optical simulation simulates how the field response of the simulated environment changes due to the excitation source over a plurality of time steps (e.g., from an initial to final time step with a pre-determined step size).

Block 1008 illustrates performing an operational circuit simulation based on output of the operational optical simulation. As described above, the field values determined during the operational optical simulation are used as input to a semiconductor simulator that determines an amount of charge generated by the photodetector layers 404, and the charge is provided to a circuit simulator to simulate the electrical signals received by the circuitry 408 while taking into account parasitic loads within the conductors 406.

Block 1010 illustrates determining a performance loss value based on comparison of the simulated circuit performance to a desired performance. In some embodiments, the simulated circuit performance (i.e., the simulated electrical signal received by the circuitry 408) may be utilized to determine one or more performance metrics of the physical device. For example, as discussed above, an eye diagram representing the simulated elecical signal may be compared to a desired eye diagram, or characteristics of the eye diagram may be measured and compared to desired characteristics.

Block 1012 shows determining a loss metric based on the performance loss value. In some embodiments the loss metric is determined via a loss function that includes the performance loss value as input values. Other values, including but not limited to fabrication loss values (a value indicating whether the design is fabricable), may be combined with the performance loss value in creating the loss metric.

Block 1014 illustrates backpropagating the loss metric via the loss function through the simulated environment to determine an influence of changes in the structural parameters on the loss metric (i.e., structural gradient) and/or an influence of changes in the circuit parameters on the loss metric (i.e., circuit parameter gradient). The loss metric may be treated as an adjoint or virtual source, and may be backpropagated incrementally from a final time step to earlier time steps in a backwards simulation to determine the structural gradient of the physical device. In some embodiments, the loss metric may instead (or also) be treated as an adjoint input to a reverse circuit simulation conducted by the circuit simulation engine 536. In some embodiments, an output of the reverse circuit simulation may be used as the adjoint input to the adjoint simulation of the optically active region 114.

Block 1016 shows revising a design of the physical device (e.g., generated a revised description) by updating the structural parameters and/or the circuit parameters of the initial design 836 to adjust the loss metric. In some embodiments, adjusting for the loss metric may reduce the loss metric. However, in other embodiments, the loss metric may be adjusted or otherwise compensated in a manner that does not necessarily reduce the loss metric. In some embodiments, the revised description is generated by utilizing an optimization scheme after a cycle of operational and adjoint simulations via a gradient descent algorithm, Markov Chain Monte Carlo algorithm, Adam optimizer, or other optimization techniques. Put in another way, iterative cycles of simulating the physical device, determining a loss metric, backpropagating the loss metric, and updating the structural parameters and circuit parameters to adjust the loss metric may be successively performed until the loss metric substantially converges such that the difference between the performance metric and the target performance metric is within a threshold range.

It should be appreciated that, in some embodiments, the changes to the circuit parameters may affect more than the size, shape, and/or location of a doped region, a conductor, or other aspects specified by the circuit parameters. For example, the changes to the circuit parameters may add or remove doped regions in order to more efficiently generate charge, and/or may add or remove conductors in order to more efficiently transfer charge from the photodetector layers 404 to the circuitry 408, in order to attempt to further improve the loss metric. In some embodiments, separate values may be tracked to represent the existence of the addable/removable characteristics, and an estimator may be used to pass gradients through to these values during the updates in order to cause the characteristics to be added or removed.

At decision block 1018, a determination is made regarding whether the further iterations should be performed, or whether the method 1000 is done optimizing the physical device. In some embodiments, iterative cycles of simulating the physical device with the excitation source, simulating the circuitry 408, backpropagating the loss metric, and revising the design by updating the structural parameters and the circuit parameters are performed to reduce the loss metric until the loss metric substantially converges such that the difference between the performance metric and the target performance metric is within a threshold range. In some embodiments, the method 1000 performs a predetermined number of iterations.

If the determination is that further iterations should be performed, then the result of decision block 1018 is NO, and the method 1000 returns to block 1004 to iterate on the revised initial design 836. Otherwise, if the determination is that the loss metric has converged, then the result of decision block 1018 is YES and the method 1000 advances to block 1020.

Block 1020 illustrates outputting an optimized design of the physical device in which the structural parameters and circuit parameters have been updated to have the difference between the performance metric and the target performance metric optimized. The method 1000 then proceeds to an end block and terminates.

One will recognize that various changes can be made to the method 1000 without departing from the scope of the present disclosure. For example, in some embodiments, the structural parameters 808 may be kept constant, and updates may only be applied to the circuit parameters 850. As another example, in some embodiments, the method 1000 may alternate between updating the structural parameters 808 for one or more iterations and then updating the circuit parameters 850 for one or more iterations, or may use different learning rates for the updates to the structural parameters 808 and the circuit parameters 850, to improve the likelihood that the design will converge to an optimal value.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A non-transitory computer-readable medium having computer-executable instructions stored thereon that, in response to execution by one or more processors of a computing system, cause the computing system to perform actions for creating a design for an optoelectronic detector device, the actions comprising:
determining, by the computing system, an initial design that includes structural parameters for an optically active region and circuit parameters for at least one photodetector region and for conductors that couple the photodetector region to circuitry;
simulating, by the computing system, performance of the optically active region to generate a plurality of field values;
simulating, by the computing system, performance of the at least one photodetector region based on the plurality of field values to generate charge values;
simulating, by the computing system, performance of at least the conductors based on the charge values to generate a performance loss value;
determining, by the computing system, a loss metric based on the performance loss value;
backpropagating, by the computing system, the loss metric to determine at least a circuit parameter gradient; and
revising, by the computing system, the circuit parameters based at least in part on the circuit parameter gradient to create an updated initial design.

2. The non-transitory computer-readable medium of claim 1, wherein the actions further comprise:
repeating the simulating performance of the optically active region, simulating performance of the at least one photodetector region, simulating performance of at least the conductors, determining the loss metric, backpropagating the loss metric, and revising the circuit parameters to further update the updated initial design.

3. The non-transitory computer-readable medium of claim 1, wherein the circuit parameters include a shape and a location of at least one doped region; and
wherein revising the circuit parameters includes changing at least one of the shape and the location of the at least one doped region.

4. The non-transitory computer-readable medium of claim 1, wherein the circuit parameters include a shape and a location of at least one conductor; and
wherein revising the circuit parameters includes changing at least one of the shape and the location of the at least one conductor.

5. The non-transitory computer-readable medium of claim 1, wherein simulating performance of at least the conductors based on the charge values includes determining a parasitic inductance of at least one contact point, via, bond wire, ball grid, trace, or wire.

6. The non-transitory computer-readable medium of claim 1, wherein the performance loss value includes a measurement of a simulated charge value received by the circuitry.

7. The non-transitory computer-readable medium of claim 6, wherein the measurement of the simulated charge value received by the circuitry includes a characteristic of an eye diagram; and
wherein determining the loss metric based on the performance loss value includes comparing the characteristic of the eye diagram to a desired characteristic of the eye diagram.

8. The non-transitory computer-readable medium of claim 7, wherein the characteristic of the eye diagram represents an amount of time to transition between logical states.

9. The non-transitory computer-readable medium of claim 7, wherein the characteristic of the eye diagram represents a signal-to-noise ratio.

10. The non-transitory computer-readable medium of claim 1, wherein simulating performance of the at least one photodetector region includes simulating the performance of the at least one photodetector region over time.

11. A computer-implemented method of creating a design for an optoelectronic detector device, the method comprising:
determining, by a computing system, an initial design that includes structural parameters for an optically active region and circuit parameters for at least one photodetector region and for conductors that couple the photodetector region to circuitry;
simulating, by the computing system, performance of the optically active region to generate a plurality of field values;
simulating, by the computing system, performance of the at least one photodetector region based on the plurality of field values to generate charge values;
simulating, by the computing system, performance of at least the conductors based on the charge values to generate a performance loss value;
determining, by the computing system, a loss metric based on the performance loss value;
backpropagating, by the computing system, the loss metric to determine at least a circuit parameter gradient; and
revising, by the computing system, the circuit parameters based at least in part on the circuit parameter gradient to create an updated initial design.

12. The computer-implemented method of claim 11, further comprising:
repeating the simulating performance of the optically active region, simulating performance of the at least one photodetector region, simulating performance of at least the conductors, determining the loss metric, backpropagating the loss metric, and revising the circuit parameters to further update the updated initial design.

13. The computer-implemented method of claim 11, wherein the circuit parameters include a shape and a location of at least one doped region; and
wherein revising the circuit parameters includes changing at least one of the shape and the location of the at least one doped region.

14. The computer-implemented method of claim 11, wherein the circuit parameters include a shape and a location of at least one conductor; and
wherein revising the circuit parameters includes changing at least one of the shape and the location of the at least one conductor.

15. The computer-implemented method of claim 11, wherein simulating performance of at least the conductors based on the charge values includes determining a parasitic inductance of at least one contact point, via, bond wire, ball grid, trace, or wire.

16. The computer-implemented method of claim 11, wherein the performance loss value includes a measurement of a simulated charge value received by the circuitry.

17. The computer-implemented method of claim 16, wherein the measurement of the simulated charge value received by the circuitry includes a characteristic of an eye diagram; and
wherein determining the loss metric based on the performance loss value includes comparing the characteristic of the eye diagram to a desired characteristic of the eye diagram.

18. The computer-implemented method of claim 17, wherein the characteristic of the eye diagram represents an amount of time to transition between logical states.

19. The computer-implemented method of claim 17, wherein the characteristic of the eye diagram represents a signal-to-noise ratio.

20. The computer-implemented method of claim 11, wherein simulating performance of the at least one photodetector region includes simulating the performance of the at least one photodetector region over time.
